(19) United States
(12) Patent Application Publication
(10) Pub. No.: US 2012/0308414 A1
(43) Pub. Date: Dec. 6, 2012

(54) INVERTER-INTEGRATED ELECTRIC COMPRESSOR

(75) Inventors: Nobuaki Ogawa, Shiga (JP); Naomi Goto, Shiga (JP); Toru Adachi, Shiga (JP); Minoru Kajitani, Shiga (JP); Nobuyuki Nishii, Shiga (JP)

(73) Assignee: PANASONIC CORPORATION, Osaka (JP)

(21) Appl. No.: 13/578,166

(22) PCT Filed: Sep. 14, 2011
(86) PCT No.: PCT/JP2011/005175

§ 371 Date: Aug. 9, 2012

(30) Foreign Application Priority Data
Sep. 16, 2010 (JP) 2010-207510
Sep. 24, 2010 (JP) 2010-213499
Aug. 3, 2011 (JP) 2011-169843

(51) Int. Cl. H02K 9/10; F04C 18/00

(52) U.S. Cl. 417/410.5; 310/55

(57) ABSTRACT

An inverter-integrated electric compressor is structured to include a suction refrigeration path (61) for intensively flowing a sucked refrigerant (30) therethrough, such that the suction refrigerant path (61) is provided only in the vicinity of a switching device module (105), which is a main heat source in an inverter device portion (101), so that the sucked refrigerant is concentrated in only the vicinity of the switching device module, which is the main heat source in the inverter device portion. This enables effectively cooling the inverter device portion, with the sucked refrigerant, without involving adjustments of operating conditions for a refrigeration cycle.

### TECHNICAL FIELD

The present invention relates to inverter-integrated electric compressors including an electric compressor for performing suction, compression and ejection on a refrigerant, and an inverter device for driving an electric motor in the electric compressor, which are integrated with each other.

### BACKGROUND ART

There have been suggested various types of inverter-integrated electric compressors incorporating inverter devices adapted to be cooled by sucked refrigerants. As such conventional inverter-integrated electric compressors, there have been those disclosed in JP-A No. 2009-97503 (Patent Literature 1) and JP-A No. 2003-201962 (Patent Literature 2), for example. There will be described a conventional inverter-integrated electric compressor disclosed in Patent Literature 1, with reference to FIGS. 23 to 25.

The conventional inverter-integrated electric compressor illustrated in FIG. 23 includes an electric compressor portion 401 which is placed in a right side, and an inverter device portion 402 which is placed in a left side, such that they are integrated with each other. The electric compressor portion 401 is provided with plural mounting legs 450 on the periphery of its body portion, and the inverter-integrated electric compressor is adapted such that it is installed laterally through these mounting legs 450.

Hereinafter, there will be described the electric compressor portion 401 in the conventional inverter-integrated electric compressor. The electric compressor portion 401 includes an electric motor portion 405 and a compressor mechanism portion 404, wherein the electric motor portion 405 drives the compressor mechanism portion 404, and the electric motor portion 405 is driven by an inverter device 402.

The compressor mechanism portion 404 is of a scroll type, wherein a fixed spiral portion 411 and a circling spiral portion 412 are engaged with each other to form a compressor space 410. As illustrated in FIG. 23, the compressor mechanism portion 404 is adapted such that the fixed spiral portion 411 having a spiral shape which is erected from a fixed end plate 411a, and the circling spiral portion 412 having a spiral shape which is erected from a circling end plate 412a are engaged with each other to form the compressor space 410.

In the compressor mechanism portion 404, the circling spiral portion 412 is driven by the electric motor portion 405 through a driving shaft 414, so that the compressor space 410 changes its capacity as it is displaced, thereby performing suction and compression on a refrigerant 430 returned from an external cycle and, further, performing ejection thereof to the external cycle.

An inverter case 406, which forms the external appearance of the inverter device portion 402, is provided with a suction port 8, while a main body casing 403 which forms the external appearance of the electric compressor portion 401 is provided with an ejection port 409.

The fixed end plate 411a in the compressor mechanism portion 404 is provided with an ejection hole 431 and a reed valve 431a. The ejection hole 431 is formed to be an opening in an ejection room 462 formed by the fixed end plate 411a and a lid member 465. The ejection room 462 communicates with the electric motor portion 405, through a communication path 463. Accordingly, the refrigerant 430 in the ejection room 462 flows toward the electric motor portion 405 and is ejected from the ejection port 409 in the main body casing 403, while cooling the electric motor portion 405. During the process from the ejection room 462 to the ejection port 409, the refrigerant is subjected to various types of gas-liquid separations such as impinging, centrifuging, throttling, thereby resulting in separation of a lubrication oil 407 therefrom.

Next, there will be described the inverter device portion 402 in the conventional inverter-integrated electric compressor.

FIG. 24 is an exploded view illustrating the portions of the inverter device portion 402 and the electric compressor portion 401 which are coupled to each other, illustrating end portions of the inverter case 406 and the main body casing 403. In FIG. 24, there is illustrated the inverter case 406 in a left side, and there is illustrated the end portion of the main body casing 403 which is provided with the fixed end plate 411a, in a right side. FIG. 25 is an exploded perspective view illustrating the inverter device portion 402.

As illustrated in FIG. 25, the inverter device portion 402 includes the inverter case 406, and an inverter cover 413 which closes the opened end portion of the inverter case 406 (the end portion in the left side in FIG. 23). The inverter case 406 and the inverter cover 413 form a space which houses, therein, an inverter circuit including a circuit board 423, an intelligent power module (IPM) 421 as a switching device module, which forms a heat source, and a current smoothing capacitor 422.

Further, a sheet member 420 having a sound insulating effect and a vibration damping effect is attached to the inner surface of the inverter cover 413, which prevents noise generated from the electric motor portion 405 or the compressor mechanism portion 404 from leaking to the outside through the inverter cover 413.

There will be described a cooling structure in the conventional inverter device portion 402 having the aforementioned structure.

As illustrated in FIG. 24, the inverter case 406 and the fixed end plate 411a in the fixed spiral portion 411 are hermetically secured to each other with an O ring 492 interposed therebetween, thereby forming a suction refrigerant path 461 communicated with the suction port 408. The suction refrigerant path 461 is formed over substantially the entire area of an end portion wall 406a in the inverter case 406, in its side closer to the compressor mechanism portion 404. Accordingly, a refrigerant 430 sucked through the suction port 408 is diffused over substantially the entire area of the end portion wall 406a in the inverter case 406 in its side closer to the compressor mechanism portion 404, in the suction refrigerant path 461, thereby cooling the entire surface of the end portion wall 406a. At this time, the refrigerant 430 absorbs heat from the heat source, such as the IPM 421 (see FIG. 25), in the inverter circuit provided within the space formed on the bask-surface side (in the inverter-circuit side) of the end portion wall 406a. The refrigerant 430 having absorbed heat is flowed into the compressor space 410 in the scroll compressor, through a path hole 471 formed in the fixed end plate 411a.

### CITATION LIST

### Patent Literatures

Patent Literature 1: Japanese Unexamined Patent Publication No. 2009-97503
Patent Literature 2: Japanese Unexamined Patent Publication No. 2003-201962

### SUMMARY OF INVENTION

### Technical Problem

The conventional inverter-integrated electric compressor having the aforementioned structure has problems as follows, regarding the cooling structure in the inverter device portion 402. Namely, in the aforementioned structure, the refrigerant 430 sucked through the suction port 408 is diffused within the suction refrigerant path 461 formed over substantially the entire area of the end portion wall 406a in the inverter case 406 in its side closer to the compressor mechanism portion 404, so that the refrigerant cools the entire area of the end portion wall 406a in its side closer to the compressor mechanism portion 404. In other words, the conventional inverter device portion 402 is structured to cause the sucked refrigerant 430 to cool even portions having relatively-lower temperatures, in the end portion wall 406a. This may cause the end portion wall 406a in the conventional inverter device portion 402 to be insufficiently cooled at its portion coincident with the position at which there is installed the IPM 421 having a highest temperature. The inverter device portion 402 has difficulty in sufficiently exerting its functions in a higher-temperature environment, which necessitates controlling the ambient temperature around the inverter device portion 402 to be equal to or less than a predetermined temperature. As described above, in the inverter-integrated electric compressor, the inverter device portion 402 is largely influenced by the temperatures at the electric motor portion 405, the compressor mechanism portion 404, the IPM 421 and the like, as well as by the ambient temperature. Therefore, with the conventional structure, the inverter device portion 402 is not structured to be efficiently and sufficiently cooled by the sucked refrigerant 430, which may prevent the inverter device portion 402 from being maintained at a temperature equal to or lower than a predetermined temperature.

When the inverter device portion can not be maintained at a temperature equal to or lower than a predetermined temperature, as described above, it is necessary to change the operating conditions for the refrigeration cycle for performing adjustments thereof in such a way as to increase the cooling ability. For example, such adjustments include adjustments of an expansion valve, adjustments of the quantity of air in a heat exchanger, adjustments of the rotation speed of the electric motor. This enables maintaining the inverter device portion at a temperature equal to or lower than a predetermined temperature. However, such adjustments change the operating conditions for the refrigeration cycle, which may degrade the comfort of air conditioning due to noise and the like, thereby degrading the operating efficiency, in cases where this electric compressor is used in an air conditioning apparatus, for example. Furthermore, in order to perform adjustments as described above, it is necessary to perform complicated control for operating the refrigeration cycle, in the inverter-integrated electric compressor.

The present invention was made in order to overcome the aforementioned conventional problems and aims at providing an inverter-integrated electric compressor which is structured to efficiently cool an inverter device portion with a refrigerant, thereby eliminating the necessity of adjusting operating conditions for a refrigeration cycle for maintaining the inverter device portion at a temperature equal to or lower than a predetermined temperature.

### Solution to Problem

In order to overcome the aforementioned conventional problems, an inverter-integrated electric compressor according to the present invention is adapted to include a suction refrigerant path for intensively flowing a sucked refrigerant, in order to cool an inverter device portion, such that the suction refrigerant path is provided only in the vicinity of a main heat source, such as an IPM, in the inverter device portion.

Accordingly, the sucked refrigerant is concentrated in the vicinity of the main heat source in the inverter device portion, which can effectively cool the vicinity of the heat source such as the IMP, which significantly raises its temperature due to concentrations of heat generated from switching devices therein. Further, the inverter device portion can be sufficiently cooled by the sucked refrigerant, thereby eliminating the necessity of adjustments of operating conditions for the refrigeration cycle.

### Advantageous Effects of Invention

With the inverter-integrated electric compressor according to the present invention, it is possible to cool the inverter device portion, with the sucked refrigerant, without involving adjustments of operating conditions for the refrigeration cycle.

### BRIEF DESCRIPTION OF DRAWINGS

FIG. 1 is a cross-sectional view illustrating the internal structure of an inverter-integrated electric compressor according to a first embodiment of the present invention.

FIG. 2 is a partial cross-sectional view illustrating a suction refrigerant path and vicinities thereof, in an inverter device portion, according to the first embodiment.

FIG. 3 is an exploded perspective view illustrating an inverter case, and an end portion of a main-body casing which is provided with a fixed end plate, according to the first embodiment.

FIG. 4 is a perspective view illustrating, in an enlarging manner, the inverter case according to the first embodiment.

FIG. 5 is an exploded view illustrating the inverter device portion according to the first embodiment.

FIG. 6 is a cross-sectional view illustrating the internal structure of an inverter-integrated electric compressor according to a second embodiment of the present invention.

FIG. 7 is a partial cross-sectional view illustrating a suction refrigerant path and vicinities thereof, in an inverter device portion, according to the second embodiment.

FIG. 8 is an exploded perspective view illustrating an inverter case, and an end portion of a main-body casing which is provided with a fixed end plate, according to the second embodiment.

FIG. 9 is a perspective view illustrating, in an enlarging manner, the inverter case according to the second embodiment.

FIG. 10 is an exploded perspective view illustrating the inverter device portion according to the second embodiment.

FIG. 11 is a cross-sectional view illustrating the internal structure of an inverter-integrated electric compressor according to a third embodiment of the present invention.

FIG. 12 is an enlarged cross-sectional view illustrating a suction refrigerant path and vicinities thereof, in an inverter case, according to the third embodiment.

FIG. 13 is an exploded view illustrating an inverter case, and a portion of a main-body casing, according to the third embodiment.

FIG. 14A is a front view of an inverter-integrated electric compressor according to a fourth embodiment of the present invention.

FIG. 14B is a left side view of the inverter-integrated electric compressor according to the fourth embodiment of the present invention.

FIG. 15 is an exploded view illustrating the portions of an inverter device portion and an electric compressor portion which are coupled to each other, according to the fourth embodiment.

FIG. 16 is an exploded view illustrating the inverter-circuit side of the inverter device portion which is provided with a switching device module, and the like, according to the fourth embodiment.

FIG. 17 is an electric circuit diagram of the inverter device portion and peripheries thereof, in the inverter-integrated electric compressor according to the fourth embodiment.

FIG. 18 is a rear view of a current smoothing capacitor according to the fourth embodiment.

FIG. 19 is a side view of the current smoothing capacitor according to the fourth embodiment.

FIG. 20 is a rear view of a current smoothing capacitor in an inverter-integrated electric compressor according to a fifth embodiment.

FIG. 21 is a rear view of a current smoothing capacitor in an inverter-integrated electric compressor according to a sixth embodiment.

FIG. 22 is a rear view of a current smoothing capacitor in an inverter-integrated electric compressor according to a seventh embodiment.

FIG. 23 is a cross-sectional view illustrating the structure of a conventional inverter-integrated electric compressor.

FIG. 24 is an exploded view illustrating the portions of an inverter device portion and an electric compressor portion which are coupled to each other, in the conventional inverter-integrated electric compressor.

FIG. 25 is an exploded perspective view illustrating the inverter device portion in the conventional inverter-integrated electric compressor.

### DESCRIPTION OF EMBODIMENTS

According to a first invention, there is provided an inverter-integrated electric compressor incorporating an inverter device portion adapted to be cooled by a sucked refrigerant, wherein there is formed a suction refrigerant path for intensively flowing the sucked refrigerant, in a surface which is opposite from a wall surface being in contact with a main heat source in the inverter device portion, at a position coincident with the position at which the main heat source is installed.

Accordingly, the inverter-integrated electric compressor according to the first invention is structured such that the sucked refrigerant is concentrated in only the vicinity of the main heat source in the inverter device portion. The main heat source in the inverter device portion induces a concentration of heat generated from the plural switching devices therein, which induces a large temperature gradient in the area which is in contact with this heat source. Therefore, this area having such a large temperature gradient therein can be effectively cooled by the sucked refrigerant flowing intensively thereon. As a result thereof, the inverter device portion can be sufficiently cooled by the sucked refrigerant, which eliminates the necessity of adjustments of operating conditions for the refrigeration cycle.

According to a second invention, in the inverter-integrated electric compressor according to the first invention, the inverter device portion is placed adjacent to a compressor mechanism portion, and the suction refrigerant path for intensively flowing the sucked refrigerant therethrough is formed between the inverter device portion and the compressor mechanism portion. Accordingly, with the inverter-integrated electric compressor according to the second invention, the sucked refrigerant can be caused to effectively absorb heat from the inverter device portion and, further, heat from the compressor mechanism portion can be prevented from being transferred to the inverter device portion.

According to a third invention, in the inverter-integrated electric compressor according to the first or second invention, the main heat source in the inverter device portion is formed from a module including integrated semiconductor chips forming plural switching devices in an inverter circuit. Since the semiconductor chips have shapes with smaller sizes, heat generated therefrom is further concentrated, thereby inducing a larger temperature gradient, in the area which is in contact with this module. With the inverter-integrated electric compressor according to the third invention, it is possible to effectively cool the module including the integrated semiconductor chips, by the suction refrigerant path for intensively flowing the sucked refrigerant.

According to a fourth invention, in the inverter-integrated electric compressor according to any one of the first to third inventions, in the surface which is opposite from the wall surface being in contact with the main heat source in the inverter device, at positions coincident with the position at which the main heat source is installed, a first path restriction portion and a second path restriction portion are formed oppositely to each other, and the first path restriction portion and the second path restriction portion form opposite side wall surfaces of the suction refrigerant path along a flow of the sucked refrigerant, whereby the sucked refrigerant intensively flows through the suction refrigerant path. Therefore, with the inverter-integrated electric compressor according to the fourth invention, it is possible to certainly cool the wall surface which is in contact with the heat source, by the suction refrigerant path for intensively flowing the sucked refrigerant.

According to a fifth invention, in the inverter-integrated electric compressor according to any one of the first to third inventions, in the wall surface being in contact with the main heat source in the inverter device portion, a first path guide portion having a concave shape and a second path guide portion having a concave shape are formed oppositely to each other, such that the heat source is inside them, and the first path guide portion and the second path guide portion form opposite side wall surfaces of the suction refrigerant path along a flow of the sucked refrigerant in the suction refrigerant path, whereby the sucked refrigerant intensively flows through the suction refrigerant path. Therefore, with the inverter-integrated electric compressor according to the fifth invention, it is possible to further concentrate heat from the main heat source in the inverter device portion, in the suction refrigerant path, since there are formed the concave portions as heat dissipation portions beside the suction refrigerant path. This induces a larger temperature gradient in the wall surface which is in contact with the heat source. However, heat from the heat source can be cooled more effectively, by the suction refrigerant path for intensively flowing the sucked refrigerant.

According to a sixth invention, in the inverter-integrated electric compressor according to any one of the first to fifth inventions, the compressor mechanism portion includes a portion which forms an ejection room adapted such that a high-pressure refrigerant is ejected thereinto, and this portion is structured to be spaced apart from the surface opposite from the wall surface being in contact with the heat source, by a substantially constant interval, over the area other than the area provided with the suction refrigerant path. Therefore, with the inverter-integrated electric compressor according to the sixth invention, it is possible to smoothly flow the sucked refrigerant through the suction refrigerant path for uniformly cooling the wall surface which is in contact with the heat source, thereby eliminating cooling unevenness.

According to a seventh invention, in the inverter-integrated electric compressor according to any one of the first to fifth inventions, the inverter device portion includes an inverter circuit including a surface-mounting type current smoothing capacitor having a flat-plate shape, and the current smoothing capacitor is mounted on a circuit board in the inverter device portion.

Therefore, with the inverter-integrated electric compressor according to the seventh invention, since the current smoothing capacitor has the flat-plate shape, there is no need for providing a member for supporting the capacitor as a countermeasure against vibrations. Further, since the current smoothing capacitor is mounted on the circuit board, there is no need for electric-connection wiring using lead wires between the current smoothing capacitor and the circuit board. Further, since the current smoothing capacitor, which is formed from a capacitor with a relatively-larger size, has the flat-plate shape and is surface-mounted on the circuit board such that it faces the circuit board, it is possible to cause the circuit board to have an increased strength against vibrations, around its portion on which the current smoothing capacitor is surface-mounted. Therefore, with the inverter-integrated electric compressor according to the seventh invention, it is possible to eliminate the necessity of providing an additional fixing means such as screws at the center portion of the circuit board, as a countermeasure against vibrations. With the inverter-integrated electric compressor according to the seventh invention, it is possible to enhance the vibration resistance of the inverter device portion, without using an additional member.

According to an eighth invention, in the inverter-integrated electric compressor according to the seventh invention, the current smoothing capacitor is formed from a ceramic capacitor. With the inverter-integrated electric compressor according to the eighth invention, it is possible to further strengthen the circuit board itself against vibrations, around its portion on which the current smoothing capacitor is surface-mounted, since such a ceramic capacitor has higher hardness and strength.

According to a ninth invention, in the inverter-integrated electric compressor according to the seventh or eighth invention, the current smoothing capacitor is secured to the circuit board, through an adhesive agent, in addition to soldering.

Therefore, with the inverter-integrated electric compressor according to the ninth invention, the surface-mounting type current smoothing capacitor is secured to the circuit board, by securing them with the adhesive agent, in addition to securing through soldering at electrode terminals. This can strengthen the securing of the current smoothing capacitor to the circuit board, which causes the circuit board itself to have an increased strength against vibrations, around the current smoothing capacitor which is surface-mounted thereon.

According to a tenth invention, in the inverter-integrated electric compressor according to the ninth invention, the current smoothing capacitor is secured to the circuit board through the adhesive agent, at an end portion of the current smoothing capacitor which is provided with no electrode terminal.

Therefore, with the inverter-integrated electric compressor according to the tenth invention, in cases where the flat-plate shaped and surface-mounting type current smoothing capacitor has a rectangular shape, all of its four sides are secured to the circuit board. This can strengthen the securing of the current smoothing capacitor to the circuit board, which causes the circuit board itself to have an increased strength against vibrations, around the current smoothing capacitor which is surface-mounted thereon. Further, it is possible to check the presence or absence of the adhesive agent after the surface mounting, since the adhesive agent is at visually-recognizable positions which are not hidden by the electrode terminals.

According to an eleventh invention, the inverter-integrated electric compressor according to any one of the first to tenth inventions is mounted in a vehicle. Even through various vibrations from the vehicle are transmitted to the inverter-integrated electric compressor, the vehicle itself can have improved reliability, since it incorporates the inverter-integrated electric compressor having enhanced vibration resistance according to the present invention.

Hereinafter, there will be described embodiments of the inverter-integrated electric compressor according to the present invention, with reference to the accompanying drawings. Further, the inverter-integrated electric compressors in the following embodiments are merely illustrative, and the inverter-integrated electric compressor according to the present invention is not limited to the structures which will be described in the embodiments and, also, includes structures based on equivalent technical concepts.

### First Embodiment

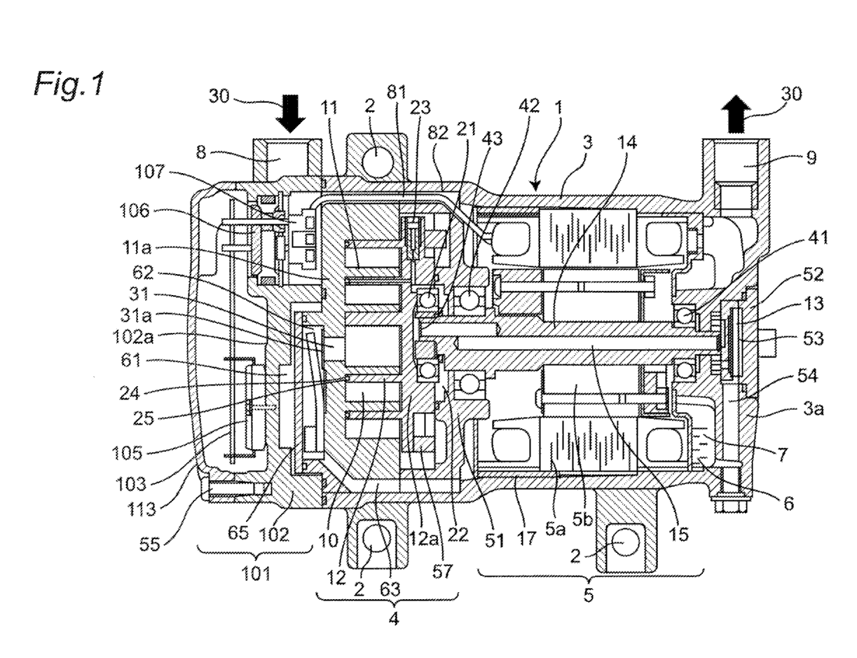

Hereinafter, an inverter-integrated electric compressor according to a first embodiment of the present invention will be described, with reference to FIGS. 1 to 5.

FIG. 1 is a cross-sectional view illustrating the internal structure of the inverter-integrated electric compressor according to the first embodiment. As illustrated in FIG. 1, the inverter-integrated electric compressor according to the first embodiment includes an electric compressor portion 1 which is placed in a right side, and an inverter device portion 101 which is placed in a left side, such that they are integrated with each other. The electric compressor portion 1 is provided, on the periphery of its body portion, with plural mounting legs 2, and the inverter-integrated electric compressor according to the first embodiment is adapted such that it is installed laterally through the mounting legs 2.

Hereinafter, there will be described the electric compressor portion 1 in the inverter-integrated electric compressor according to the first embodiment.

The electric compressor portion 1 includes an electric motor portion 5 and a compressor mechanism portion 4, such that the electric motor portion 5 and the compressor mechanism portion 4 are housed within a main-body casing 3 in the electric-compressor portion 1. The electric motor portion 5 drives the compressor mechanism portion 4 which is fitted or press-fitted in the main-body casing 3. The electric motor portion 5 is driven by being supplied with controlled electric power from the inverter device portion 101.

The compressor mechanism portion 4 includes a scroll-type compressor mechanism, wherein a fixed spiral portion 11 and a circling spiral portion 12 are engaged with each other to form a compressor space 10. As illustrated in FIG. 1, the fixed spiral portion 11 is constituted by a spirally-shaped vane extending toward the electric motor portion 5 in the thrust direction of the electric motor portion 5 and, further, is formed to be erected toward the electric motor portion 5 from a fixed end plate 11a having a surface orthogonal to the thrust direction. On the other hand, the circling spiral portion 12 is constituted by a spirally-shaped vane extending toward the inverter device portion 101 in the thrust direction of the electric motor portion 5 and, further, is formed to be erected toward the inverter device portion 101 from a circling end plate 12a having a surface orthogonal to the thrust direction. As described above, the compressor mechanism portion 4 is structured such that the fixed spiral portion 11 having the spiral shape which is erected from the fixed end plate 11a, and the circling spiral portion 12 having the spiral shape which is erected from the circling end plate 12a are engaged with each other to form the compressor space 10.

In the compressor mechanism portion 4, the circling spiral portion 12 is driven by the electric motor portion 5 through a driving shaft 14, so that the circling spiral portion 12 makes circling motions in a circular orbit with respect to the fixed spiral portion 11. When the circling spiral portion 12 makes circling motions as described above, the compressor space 10 formed by the circling spiral portion 12 and the fixed spiral portion 11 is moved. Along with the movement of the compressor space 10, the compressor space 10 changes its capacity, thereby performing suction and compression on a refrigerant 30 returned from an external cycle and, further, performing ejection thereof to the external cycle.

An inverter case 102, which forms the external appearance of the inverter device portion 101, is provided with a suction port 8, while the main-body casing 3 which forms the external appearance of the electric compressor portion 1 is provided with an ejection port 9.

In the inverter-integrated electric compressor, the refrigerant 30 used therein is a gas refrigerant, while a lubrication oil 7 or another liquid is employed as a liquid which functions to lubricate respective sliding portions and to seal the sliding portions in the compressor mechanism portion 4. The lubrication oil 7 is compatible with the refrigerant 30.

The lubrication oil 7 which is stored in a liquid reservoir portion 6 formed in a bottom portion of the main-body casing 3 is supplied to the compressor mechanism portion 4 through a positive-displacement pump 13. Namely, if the pump 13 is driven by the electric motor portion 5, the lubrication oil 7 is supplied to a liquid storage 21 formed near the back surface of the circling spiral portion 12, through an oil supply path 15 inside the driving shaft 14. A portion of the lubrication oil 7 supplied to the liquid storage 21 passes by the back surface of the circling spiral portion 12, then is restricted in amount to a predetermined amount through a throttle mechanism 23 and the like, and is supplied to the vicinity of the back surface of the outer peripheral portion of the circling spiral portion 12. As a result thereof, the circling spiral portion 12 is pushed thereby at its back surface.

Further, a portion of the lubrication oil 7 is further supplied to a retaining slot 25 at the tip end of the vane in the circling spiral portion 12, through an oil supply hole in the circling spiral portion 12. This provides sealing and lubrication between the fixed spiral portion 11 and the circling spiral portion 12. The retaining slot 25, which is supplied with the lubrication oil 7, is adapted to retain a sealing member such as a chip seal 24, between it and the fixed spiral portion 11.

Another portion of the lubrication oil 7 supplied to the liquid storage 21 passes through an eccentric bearing 43, a liquid storage 22 and a main bearing 42 to lubricate these bearings 42 and 43, then, is discharged, therefrom, toward the electric motor portion 5, and is collected in the liquid reservoir portion 6.

Inside the main-body casing 3, there are placed the pump 13, an auxiliary bearing 41, the electric motor portion 5, and a main bearding member 51 which holds the main bearing 42, from one end portion wall 3a (in the right end side in FIG. 1) in the thrust direction of the electric motor portion 5. The pump 13 is housed in a center portion of the end wall portion 3a of the main-body casing 3 and, further, is adapted to be held between the main-body casing 3 and a lid member 52, since the lid member 52 is fitted thereto after the pump 13 is housed therein. The lid member 52 is provided, in its inner side, with a pump room 53, such that it communicates with the liquid reservoir portion 6 through a suction path 54.

The electric motor portion 5 includes a stator 5a which is secured to the main-body casing 3, through an annular member 17. However, the stator 5a in the electric motor portion 5 can be also directly secured to the main-body casing 3 through sintering. On the other hand, the electric motor portion 5 includes a rotator 5b which is secured to the outer periphery of a midway portion of the driving shaft 14, such that it faces the stator 5a. Further, the circling spiral portion 12 in the compressor mechanism portion 4 is secured to an end portion of the driving shaft 14, such that it can circle. Accordingly, the electric motor portion 5 being supplied with controlled electric power from the inverter device portion 101 is caused to rotate the driving shaft 14 together with the rotator 5b, thereby circling the circling spiral portion 12 in the compressor mechanism portion 4.

The driving shaft 14 is rotatably held by the main bearing 42, and the main bearing member 51 which fixes the main bearing 42 is secured to the fixed spiral portion 11 through bolts (not illustrated). Further, the main bearing member 51 is fitted and secured to an opened end of the main-body casing 3. The main bearing portion 51 is provided in a state where it is sandwiched between the inverter case 102 and the main-body casing 3, such that the fixed spiral portion 1 in the compressor mechanism portion 4 is interposed therebetween, thereby holding the main bearing 42 which rotatably holds the driving shaft 14 at its side near the compressor mechanism portion 4.

Between the main bearing member 51 and the fixed spiral portion 11, the circling spiral portion 12 is placed such that it is sandwiched therebetween, and the fixed spiral portion 11 and the circling spiral portion 12 form the scroll compressor. Between the main bearing member 51 and the circling spiral portion 12, there is provided a mechanism, such as an oldham ring 57, as a rotation constraint member for causing the circling spiral portion 12 to make circular motions while preventing the rotation thereof. The rotational force from the electric motor portion 5 is transmitted to the circling spiral portion 12 through the driving shaft 14 supported by the eccentric bearing 43, so that the circling spiral portion 12 is circled in a circular orbit.

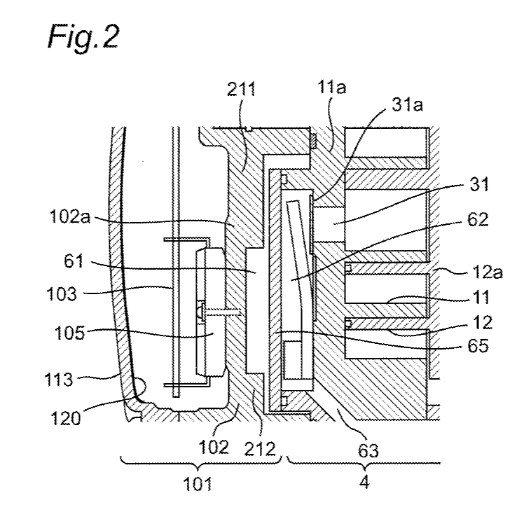

FIG. 2 is a partial cross-sectional view illustrating a suction refrigerant path 61 and vicinities thereof, in the inverter device portion 101. As illustrated in FIG. 2, the fixed end plate 11a in the compressor mechanism portion 4 is provided with an ejection port 31 and a reed valve 31a. The ejection hole 31 is formed to be an opening in an ejection room 62 formed by the fixed end plate 11a and a lid member 65. The ejection room 62 communicates with the electric motor portion 5, through a communication path 63 formed through the fixed spiral portion 11, between the fixed spiral portion 11 and the main-body casing 3, between the main bearing member 51 and the main-body casing 3, and the like. Accordingly, the refrigerant 30 in the ejection room 62 is flowed toward the electric motor portion 5 and is ejected from the ejection port 9 in the main-body casing 3, while cooling the electric motor portion 5. During the long process from the ejection room 62 to the ejection port 9, the refrigerant 30 is subjected to various types of gas-liquid separations such as impinging, centrifuging, throttling, thereby separating the lubrication oil 7. Further, the refrigerant 30 flowed to the electric motor portion 5 is also caused to lubricate the auxiliary bearing 41 through a portion of the lubrication oil 7 accompanying it.

Next, there will be described the inverter device portion 101 in the inverter-integrated electric compressor according to the first embodiment.

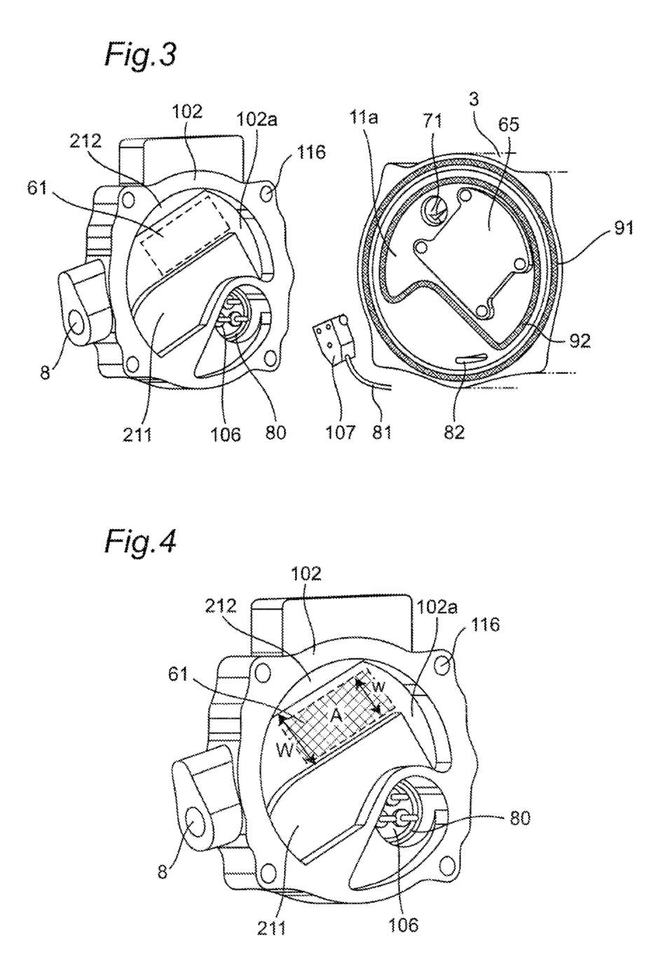

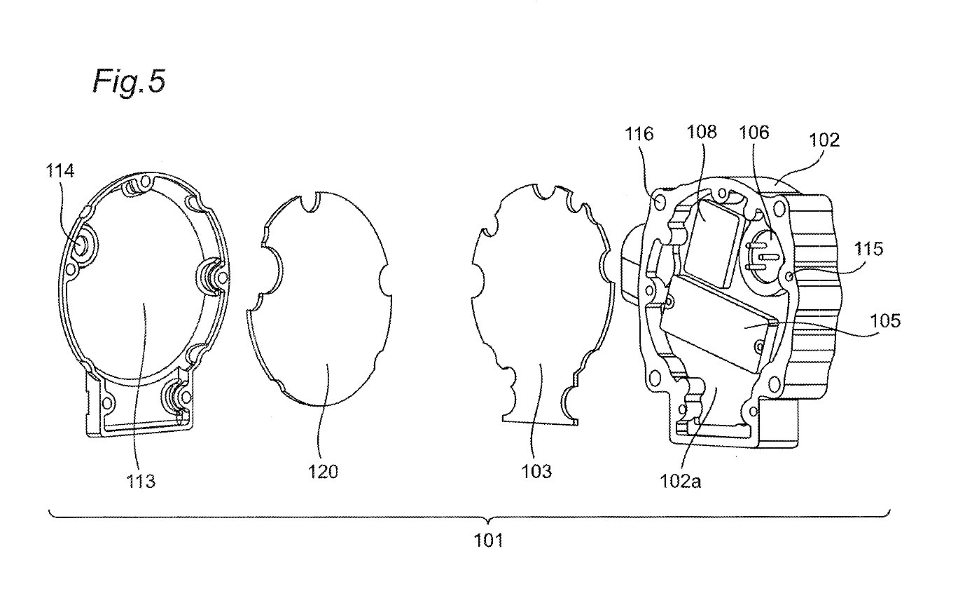

FIG. 3 is an exploded perspective view illustrating the inverter case 102 (the left side in FIG. 2), and the end portion of the main-body casing 3 which is provided with the fixed end plate 11a (the right side in FIG. 2). FIG. 4 is a perspective view illustrating the inverter case 102, in an enlarging manner. Further, FIG. 5 is an exploded perspective view illustrating the inverter device portion 101 including an inverter cover 113, the inverter case 102 housing the inverter circuit, and the like.

As illustrated in FIG. 3, the inverter case 102 is fastened to the main-body casing 3 through bolts (not illustrated) passed through bolt passage holes 116, such that it is in a hermetic state through an O ring 91. Further, the inverter case 102 and the fixed end plate 11a in the fixed spiral portion 11 are brought into hermetically intimate contact with each other, with an O ring 92 interposed therebetween, so that there is formed the suction refrigerant path 61 communicated with the suction port 8.

FIG. 5 is an exploded view illustrating the inverter device portion 101 according to the first embodiment. As illustrated in FIG. 5, the inverter device portion 101 includes an inverter circuit including a circuit board 103, a power module 105 and a current rectification capacitor 108, which is provided within the space (an inverter-circuit space) formed by the inverter case 102 and the inverter cover 113 which closes the opened end portion of the inverter case 102 (the opened end portion in the left side in FIG. 5). In the first embodiment, the power module 105 is constituted by an intelligent power module (IPM) including plural switching devices integrated therein. The IPM 105 forms a main heat source in the inverter circuit, since it includes the plural switching devices.

In the first embodiment, in the inverter case 102, in the opposite sides thereof, there are placed the suction refrigerant path 61 communicated with the suction port 8, and a space provided with the inverter circuit. The space which forms the suction refrigerant path 61 and the space provided with the inverter circuit are provided at positions close to each other and adjacent to each other, such that an end portion wall 102a closing a midway portion of the inverter case 102 is interposed therebetween.

A lead wire 81 extended from the electric motor portion 5 is connected to a harness connector 107 through a communication path 82 provided near the outer periphery of the fixed end plate 11a and, further, is inserted in and secured to a compressor terminal 106 mounted in the inverter case 102 (see FIG. 3). The compressor terminal 106 is electrically connected to the circuit board 103 in the inverter circuit. The compressor terminal 106 is secured to the inverter case 102 through a snap ring 80 as a retaining tool (see FIG. 4).

The temperature at the IPM 105 in the inverter circuit, the temperature at the electric motor portion 5 and the like are detected by temperature sensors (not illustrated). Information about the detected temperatures is monitored by a control portion provided in the inverter circuit, and the control portion drives and controls the electric motor portion 5, based on the information about the detected temperatures. The inverter device portion 101 is provided with a harness connector (not illustrated) for electrically connecting the inverter circuit to an outside.

As illustrated in FIG. 5, the space provided with the inverter circuit, in the inverter case 102, is closed by the inverter cover 113. The inverter cover 113 is secured to the inverter case 102, through screws 55 (see FIG. 1) fastened to plural screw holes 115 in the inverter case 102 through screw passage holes 114 in the inverter cover 113. Since the inverter cover 113 is secured to the inverter case 102, the inverter circuit and the like in the inverter device portion 101 are protected thereby.

Further, a sheet member 120 having a sound insulating effect and a vibration damping effect is attached to the inner surface of the inverter cover 113, which prevents noise generated from the electric motor portion or the compressor mechanism portion 4 from leaking to the outside through the inverter cover 113.

As described above, in the inverter-integrated electric compressor according to the first embodiment, the suction refrigerant path 61 for passing, therethrough, the refrigerant (the sucked refrigerant) 30 which has been sucked through the suction port 8 is formed by the inverter case 102 and the fixed end plate 11a in the fixed spiral portion 11 which are in hermetically intimate contact with each other with the O ring 92 interposed therebetween. The suction refrigerant path 61 according to the first embodiment is adapted such that its flow path for passing the sucked refrigerant 30 is restricted by a first path restriction portion 211 and a second path restriction portion 212 which are provided inside the inverter case 102.

Further, as illustrated in FIG. 1 and FIG. 2, the length of the suction refrigerant path 61 in the thrust direction (the height of the suction refrigerant path 61) is restricted by the lid member 65 and the inverter case 102.

The lid member 65 which forms the ejection room 62 in the compressor mechanism portion 4 is raised to a higher temperature and, therefore, is placed with a predetermined gap interposed between it and the end portion wall 102a in the inverter case 102, in order to prevent heat from the lid member 65 from being directly transferred to the end portion wall 102a, as illustrated in FIG. 2.

In the end portion wall 102a in the inverter case 102 illustrated in FIG. 4, an area A encircled by a broken line indicates the position at which there is placed the IPM 105 provided on the end portion wall 102a in its inverter-circuit side, which is the back-surface side thereof. In the inverter circuit, the IPM 105 mounted on the circuit board 103 is a flat-plate shaped module and is secured through screwing to the end portion wall 102a in the inverter case 102. Accordingly, the IPM 105 having the flat-plate shape is completely in intimate contact, at its top-side flat surface, with the wall surface of the end portion wall 102a. As a result thereof, heat from the IPM 105, which is a main heat source in the inverter circuit, is directly transferred to the end portion wall 102a in the inverter case 102 and, thus, the end portion wall 102a functions as a heat dissipation plate. The inverter case 102 is made of an aluminum material which is easy to process and has an excellent heat transfer property.

As illustrated in FIGS. 1 to 4, the suction refrigerant path 61 according to the first embodiment is adapted such that its wall surface closer to the inverter-circuit space is constituted by a wall surface having substantially the same width as that of the area (A) coincident with the position at which the IPM 105 is installed on the end portion wall 102a (the length thereof which is orthogonal to the direction of the flow of the sucked refrigerant 30). As a result thereof, since the sucked refrigerant from the suction port 8 passes through the suction refrigerant path 61, the refrigerant 30 intensively flows on the wall surface (A) of the end portion wall 102a which is coincident with the position at which there is installed the IPM 105, which is a main heat source in the inverter circuit.

As described above, the sucked refrigerant 30 from the suction port 8 formed in the inverter case 102 is flowed through the suction refrigerant path 61 to certainly cool the entire wall surface (A) of the end portion wall 102a which is coincident with the position at which the IPM 105 is installed thereon. The suction refrigerant path 61 is narrowed, in its flow path, by the first path restriction portion 211 and the second path restriction portion 212, thereby defining the wall surface (A) of the end portion wall 102a which is coincident with the position at which the IPM 105 is installed thereon. Therefore, the sucked refrigerant 30 intensively flows through the suction refrigerant path 61 having the narrowed flow path, thereby certainly cooling the wall surface (A) of the wall portion wall 102 which is coincident with the position at which the IPM 105 is installed. Particularly, the sucked refrigerant 30 flowing through the narrowed suction refrigerant path 61 is intensively flowed on the wall surface of the end portion wall 102a which is coincident with the position at which the IPM 105 is installed thereon, thereby strongly cooling it. After cooling the predetermined area of the end portion wall 102a, the refrigerant 30 passes through a path hole 71 in the fixed end plate 11a and flows into the compressor space 10.

In the first embodiment, as illustrated in FIG. 4, the length W (the width) of the suction refrigerant path 61 which is orthogonal to the direction of the flow of the sucked refrigerant 30, which is defined by the first path restriction portion 211 and the second path restriction portion 212, is made substantially equal to the width w of the installed IPM 105, or the width W of the suction refrigerant path 61 is made slightly larger than the width w of the IPM 105.

As described above, the inverter-integrated electric compressor according to the first embodiment is structured such that most of the refrigerant 30 is intensively flowed on the wall surface of the end portion wall 102a which is coincident with the IPM 105, which is a main heat source in the inverter device portion 101. The IPM 105 is installed within a smaller area, which induces a concentration of heat generated therefrom. This induces an abrupt temperature rise in the end portion wall 102a in the inverter case 102 in its area corresponding to the position at which the IPM 105 is installed thereon, thereby inducing a larger temperature gradient therein. However, in the inverter-integrated electric compressor according to the first embodiment, most of the refrigerant (the sucked refrigerant) 30 which has been sucked through the suction port 8 is intensively flowed through the narrowed sucked refrigerant path 61 having a certain shape, thereby effectively cooling a certain area of the end portion wall 102a.

Further, it is possible to provide heat dissipation fins in the suction refrigerant path 61, in the inverter-integrated electric compressor according to the first embodiment, which raises an expectation for an enhanced cooling effect. For example, by providing one or more heat dissipation fins on the end portion wall 102a forming the suction refrigerant path 61, in parallel with the flow of the sucked refrigerant 30, it is possible to perform effective cooling with a smaller resistance against the flow of the sucked refrigerant 30.

In the inverter-integrated electric compressor according to the first embodiment, the IPM 105 employed in the inverter circuit is a module including integrated semiconductor chips which form the output switching devices in the inverter circuit. The semiconductor chips have shapes with smaller sizes, which further enhances the concentration of heat generation therefrom, thereby resulting in a larger temperature gradient, in comparison with cases where individual switching devices are placed separately from each other. However, in the inverter-integrated electric compressor according to the first embodiment, the sucked refrigerant 30 intensively flows through the narrowed suction refrigerant path 61 to intensively flow on the area coincident with the position at which the IPM 105 is installed, thereby certainly and effectively cooling the area coincident with the position at which the IPM 105 is installed. As a result thereof, with the inverter-integrated electric compressor according to the first embodiment, there is no need for adjusting the conditions for operations of the refrigeration cycle in order to certainly maintain the inverter device portion at a temperature equal to or lower than a predetermined temperature. Therefore, when it is applied to an air conditioning apparatus, for example, it is possible to ensure comfort of air conditioning and an excellent operating efficiency.

As described above, with the inverter-integrated electric compressor according to the first embodiment, it is possible to efficiently cool the inverter device portion, with the sucked refrigerant, without adjusting the operating conditions for the refrigeration cycle.

Further, while the first embodiment has been described by exemplifying the intelligent power module (IPM) 105 including the switching devices, as a main heat source in the inverter device portion, the structure according to the first embodiment can be also applied to cases where individual output switching devices are provided separately from each other. In this case, the positions at which the individual output switching devices are installed are such that they are collectively placed at certain positions on an end portion wall which functions as a heat dissipation plate, and a suction refrigerant path is formed in an area coincident with this placement.

Further, while the structure according to the first embodiment has been described with respect to an example where the space in the suction refrigerant path 61 in the thrust direction (in the axial direction of the electric motor portion 5) is restricted by the lid member 65 and the end portion wall 102a in the inverter case 102, the surface facing the end portion wall 102a is not limited to the lid member 65, and this space can be restricted by the fixed end plate 11a or the like.

Further, in order to perform efficient heat exchange on the sucked refrigerant 30 through the end portion wall 102a in the suction refrigerant path 61, the suction refrigerant path 61 is desirably shaped such that the width of the suction refrigerant path 61 (the distance (, W) between the first path restriction portion 211 and the second path restriction portion 212) is larger than the height of the suction refrigerant path 61 (the distance between the end portion wall 102a and the lid member 65), in the directions orthogonal to the direction of the flow of the sucked refrigerant 30 in the suction refrigerant path 61.

### Second Embodiment

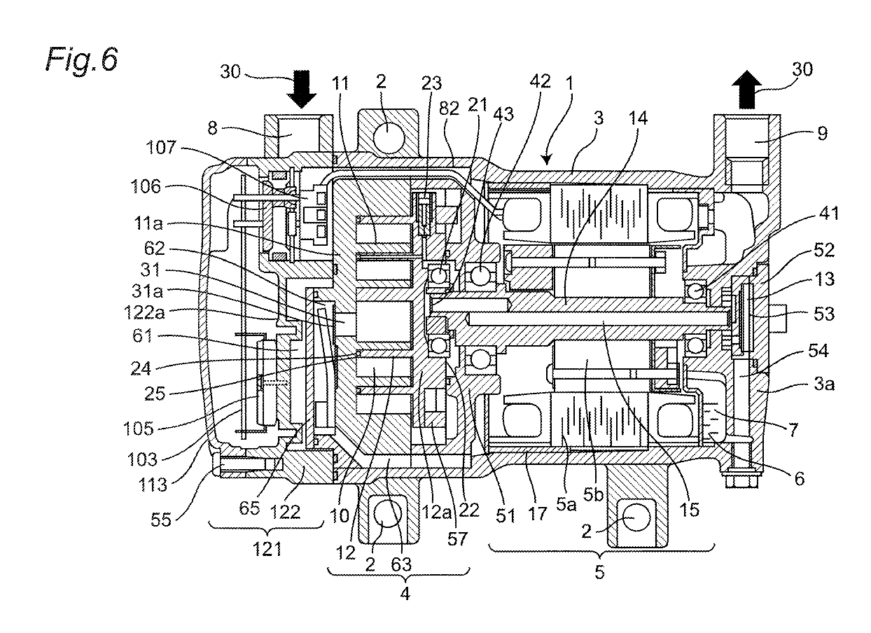

Hereinafter, an inverter-integrated electric compressor according to a second embodiment of the present invention will be described, with reference to the accompanying FIGS. 6 to 10. The inverter-integrated electric compressor according to the second embodiment is different, in structure, from the inverter-integrated electric compressor according to the aforementioned first embodiment, in terms of the cooling structure in an inverter device portion. Accordingly, in the second embodiment, the components having substantially the same functions and the same structures as those in the structure of the inverter-integrated electric compressor according to the first embodiment will be designated by the same reference characters and will not be described herein. Further, the second embodiment will be described by designating the inverter device portion by a reference character “121”, and by designating an inverter case by a reference character “122”.

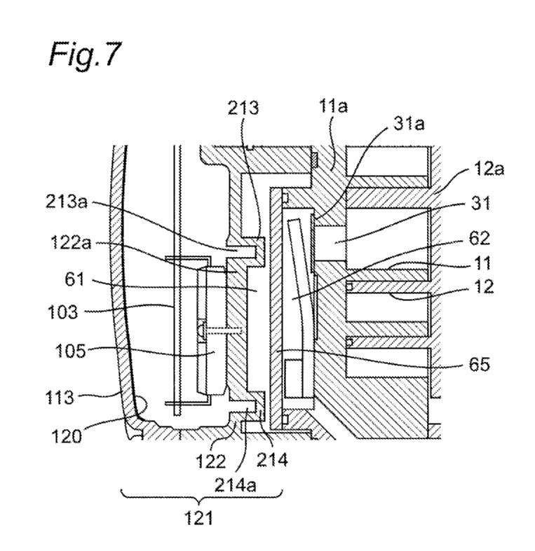

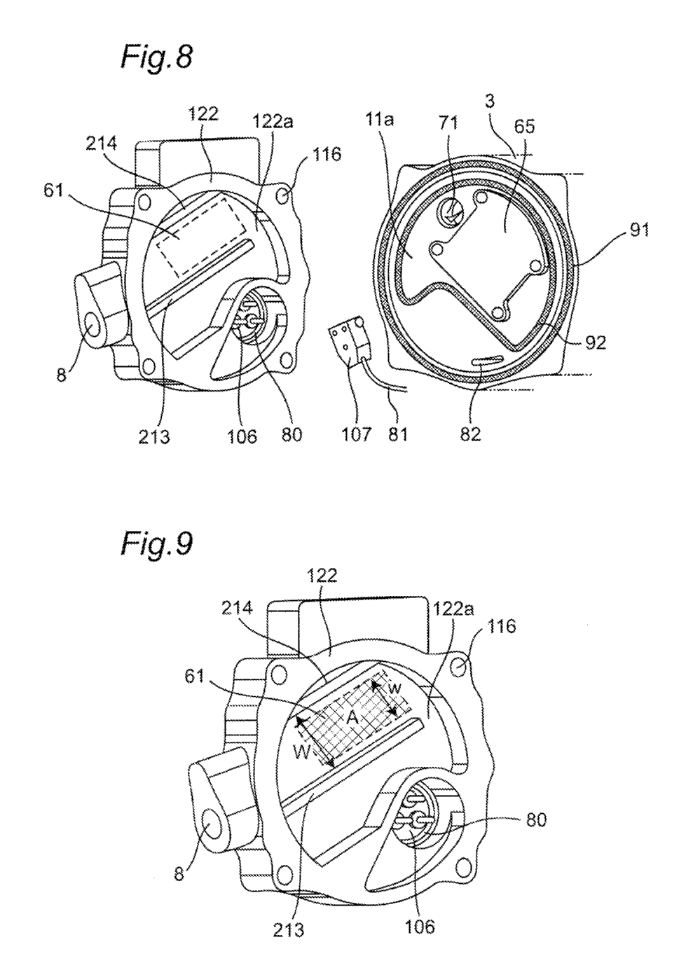

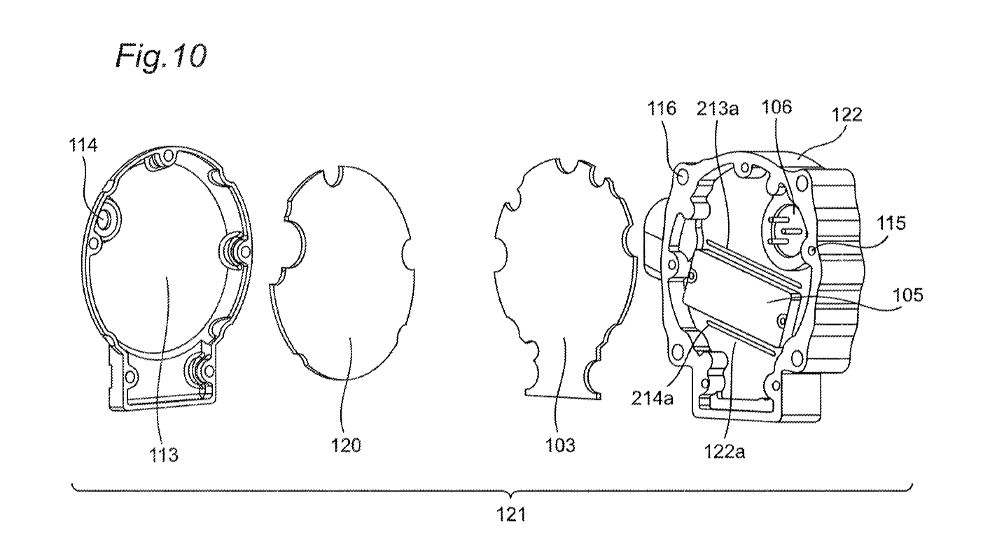

FIG. 6 is a cross-sectional view illustrating the internal structure of the inverter-integrated electric compressor according to the second embodiment. FIG. 7 is a partial cross-sectional view illustrating a suction refrigerant path 61 and vicinities thereof, in the inverter device portion 121. FIG. 8 is an exploded perspective view illustrating the inverter case 122 (in a left side in FIG. 8, and an end portion of a main-body casing 3 which is provided with a fixed end plate 11a (in a right side in FIG. 8). FIG. 9 is a perspective view illustrating the inverter case 122, in an enlarging manner. FIG. 10 is an exploded perspective view illustrating the inverter device portion 121 including an inverter cover 113, the inverter case 122 housing an inverter circuit, and the like.

In the inverter-integrated electric compressor according to the second embodiment, the cooling structure for the inverter device portion 121 is adapted to form a first path guide portion 213 and a second path guide portion 214 in the suction refrigerant path 61, which restricts the flow path for the sucked refrigerant 30. Since the first path guide portion 213 and the second path guide portion 214 are provided in the suction refrigerant path 61, the sucked refrigerant 30 from a suction port 8 is guided to the first path guide portion 213 and the second path guide portion 214, so that the sucked refrigerant 30 intensively flows on the compressor-side wall surface of an end portion wall 122a which is coincident with the position at which there is installed an IPM 105, which is a main heat source in the inverter circuit.

Further, as illustrated in FIGS. 6, 7 and 10, the end portion wall 122a is provided, in its inverter-circuit-side wall surface, with a first concave portion 213a at a position coincident with the first path guide portion 213 and, similarly, is provided with a second concave portion 214a at a position coincident with the second path guide portion 214.

Accordingly, the end portion wall 122a in the inverter case 122 is provided, in the compressor side thereof, with the first path guide portion 213 and the second path guide portion 214 which form protruding portions defining the opposite sides of the suction refrigerant path 61 and having a heat dissipation function. Further, the end portion wall 122a in the inverter case 122 is provided, in the inverter-circuit side thereof, with the first concave portion 213a and the second concave portion 214a, along opposite sides of the IPM 105 which is a heat source.

Further, referring to FIG. 9, an area A in the end portion wall 122a which is encircled by a broken line indicates the area coincident with the position at which there is installed the IPM 105, which is provided on the inverter-circuit side of the end portion wall 122a, which is the back-surface side thereof. In the second embodiment, similarly to in the first embodiment, the IPM 105 is secured through screwing to the end portion wall 102a in the inverter case 102 and, thus, is in contact with the end portion wall 102a. In the second embodiment, the IPM 105 is installed over a rectangular-shaped position, and the longitudinal direction thereof is made coincident with the direction of the flow of the sucked refrigerant 30. In the second embodiment, as illustrated in FIG. 9, the length W (the width) of the suction refrigerant path 61 which is orthogonal to the direction of the flow of the sucked refrigerant 30, which is defined by the first path guide portion 213 and the second path guide portion 214, is made substantially equal to the width w of the IPM 105, or the width W of the suction refrigerant path 61 is made slightly larger than the width w of the IPM 105.

In the inverter-integrated electric compressor having the aforementioned structure according to the second embodiment, the end portion wall 122a in the inverter case 122 is provided with the first concave portion 213a and the second concave portion 214a along the opposite sides of the IPM 105, which suppresses heat conduction in the lateral direction from the IPM 105, namely heat conduction in the direction orthogonal to the direction of the flow of the refrigerant 30. Further, since the first concave portion 213a and the second concave portion 214a are formed by forming the first path guide portion 213 and the second path guide portion 214 to be protruding portions, heat from the IPM 105, which is a main heat source in the inverter device 121, is intensively dissipated to the suction refrigerant path 61 through the protruding portions formed by the first path guide portion 213 and the second path guide portion 214. Therefore, heat from the IPM 105, which is a main heat source in the inverter circuit, is conducted to the end portion wall 122a in the suction refrigerant path 61 defined by the first path guide portion 213 and the second path guide portion 214, which suppresses heat conduction to other areas of the end portion wall 122a than the area of the suction refrigerant path 61. Accordingly, since the sucked refrigerant 30 from the suction port 8 is flowed through the suction refrigerant path 61 defined by the first path guide portion 213 and the second path guide portion 214, it is possible to perform efficient heat exchange through the end portion wall 122a in the suction refrigerant path 61, thereby resulting in effective cooling.

As described above, with the inverter-integrated electric compressor according to the second embodiment, it is possible to efficiently and sufficiently cool the inverter device portion, with the sucked refrigerant, without adjusting the operating conditions for the refrigeration cycle.

Further, although the inverter-integrated electric compressor according to the second embodiment illustrated in FIG. 10 has been described with respect to an example where no current smoothing capacitor is provided in the inverter case, a current smoothing capacitor can be provided at another proper position, for example, on the circuit board in the inverter circuit.

Further, it is also possible to provide heat dissipation fins in the suction refrigerant path 61, in the inverter-integrated electric compressor according to the second embodiment, which can further enhance the cooling effect, as described in the aforementioned first embodiment.

### Third Embodiment

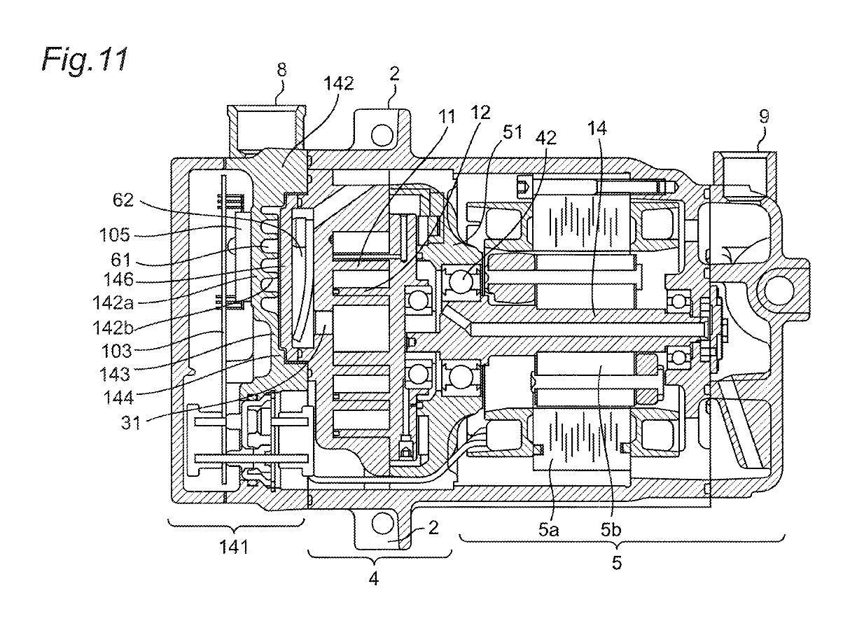

Hereinafter, an inverter-integrated electric compressor according to a third embodiment of the present invention will be described, with reference to the accompanying FIGS. 11 to 13. The inverter-integrated electric compressor according to the third embodiment is different, in structure, from the inverter-integrated electric compressor according to the aforementioned first embodiment, in terms of the cooling structure in an inverter device portion. Accordingly, in the third embodiment, the components having substantially the same functions and the same structures as those in the structure of the inverter-integrated electric compressor according to the first embodiment will be designated by the same reference characters and will not be described herein. Further, the third embodiment will be described by designating the inverter device portion by a reference character “141”, and by designating an inverter case by a reference character “142”.

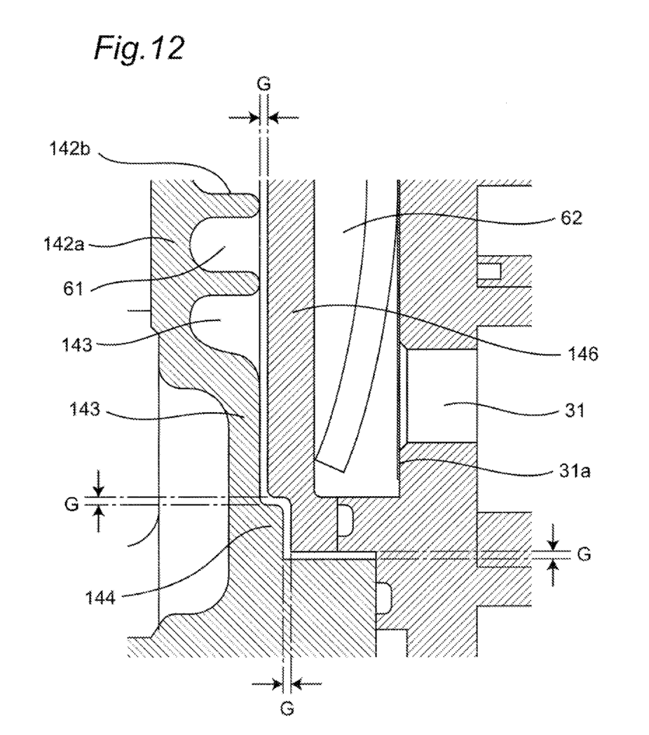

FIG. 11 is a cross-sectional view illustrating the internal structure of the inverter-integrated electric compressor according to the third embodiment. FIG. 12 is an enlarged cross-sectional view illustrating a refrigerant suction path and vicinities thereof, inside the inverter case.

As illustrated in FIG. 11, in the inverter-integrated electric compressor according to the third embodiment, there are formed plural heat dissipation fins 142b, on an end portion wall 142a in the inverter case 142 which forms the suction refrigerant path 61, in the compressor side thereof. The plural heat dissipation fins 142b are formed on the wall surface of the end portion wall 142b which is coincident with the position at which there is installed a module (IPM) 105 including integrated switching devices, which is a main heat source in the inverter circuit.

Further, the inverter-integrated electric compressor according to the third embodiment is different from that according to the aforementioned second embodiment, in terms of the cooling structure in the inverter device portion 101, in that the gap (G) between the end portion wall 142a in the inverter case 142 and a lid member 146 mounted in a fixed spiral portion 11 in a compressor mechanism portion 4 is made to be substantially constant. The area over which this gap (G) is defined is the area of the end portion wall 142a in which the suction refrigerant path 61 is not formed. Further, in the third embodiment, the gap (G) between the lid member 146 and the tip ends of the heat dissipation fins 142b formed in the suction refrigerant path 61 is also made to have the same length as that of the gap (G) between the end portion wall 142a and the lid member 146 (see FIG. 12).

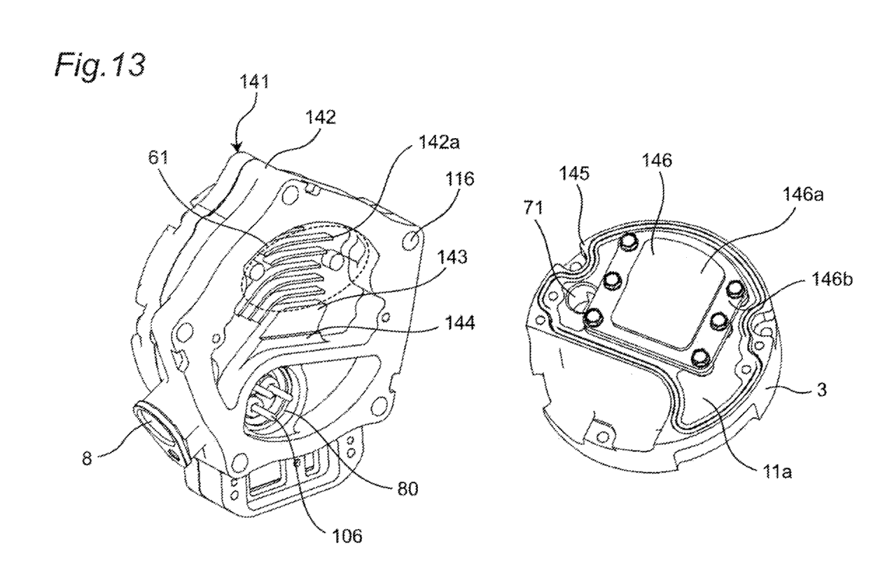

FIG. 13 is an exploded view illustrating the inverter case 142 (in a left side in FIG. 13), and a portion of a main-body casing 3 which is mounted to the inverter case 142 (in a right side in FIG. 13). As illustrated in FIG. 13, the lid member 146 is secured through plural bolts to the fixed end plate 11a in the main-body casing 3. The lid member 146 has a level difference in its surface near the suction refrigerant path 61. The lid member 146 is protruded at its center portion toward the suction refrigerant path 61 with respect to its outer peripheral portion. The center portion of the lid member 146 is a first step portion 146a, and the outer peripheral portion thereof is a second step portion 146b.

The lid member 146 in the compressor mechanism portion 4 is raised to a higher temperature and, therefore, it is necessary to provide a space equal to or larger than a predetermined gap, as a heat insulation space between the lid member 146 and the end portion wall 142a in the inverter case 142. Such a predetermined gap as a heat insulation space preferably has a size of from 0.4 mm to 1.6 mm and, thus, preferably has a size of from −0.6 mm to +0.6 mm with respect to a center gap of 1.0 mm.

In the third embodiment, the gap (G) between the lid member 146 and the end portion wall 142a is set to be substantially constant, over the area within which the suction refrigerant path 61 is not formed. As illustrated in FIG. 13, in the third embodiment, the lid member 146 is shaped to have the first step portion 146a and the second step portion 146b and, therefore, the end portion wall 142a is provided with a first gap formation portion 143 and a second gap formation portion 144 such that it conforms to the shape of the lid member 146.

In the inverter-integrated electric compressor having the aforementioned structure according to the third embodiment, when the sucked refrigerant 30 from the suction port 8 flows through the suction refrigerant path 61, since the gap between the lid member 146 and the end portion wall 142a is formed to be substantially constant, most of the refrigerant 30 flows through the suction refrigerant path 61 and comes into contact with the heat dissipation fins 142b and the end portion wall 142a, as a heat dissipation plate, to perform heat exchange therewith and, then, passes through a path hole 71 in the fixed end plate 11a to flow into the compression space.

In the inverter-integrated electric compressor according to the third embodiment, since the gap (G) between the lid member 146 and the end portion wall 142a is set to be substantially constant, except the area of the suction refrigerant path 61, the sucked refrigerant 30 is smoothly flowed through the suction refrigerant path 61 without inducing disturbances in the flow of the sucked refrigerant 30. This allows the sucked refrigerant 30 to uniformly cool the entire surface of the end portion wall 142a which is in contact with the heat source, without inducing cooling unevenness in the suction refrigerant path 61. Further, the sucked refrigerant 30 is flowed through the entire suction refrigerant path 61 without being concentrated in a portion thereof, which enables setting a larger to-be-cooled area in the end portion wall 142a as a heat dissipation plate. Therefore, the structure according to the third embodiment enables forming the suction refrigerant path 61 to have a larger size, which enables placing a larger number of heat sources on the end portion wall 142a.

As described above, with the inverter-integrated electric compressor according to the third embodiment, it is possible to efficiently and sufficiently cool the inverter device portion, with the sucked refrigerant, without adjusting the operating conditions for the refrigeration cycle.

Further, while the inverter-integrated electric compressor according to the third embodiment has been described with respect to an exemplary structure which forms the heat dissipation fins in the suction refrigerant path 61 for further enhancing the cooling effect, it is also possible to offer an excellent effect of smoothing the flow of the refrigerant for uniformly cooling the heat dissipation portion, even with a suction refrigeration path provided with no heat dissipation fin according to specifications of the inverter device portion and the like.

(Countermeasures Against Vibrations in the Inverter-Integrated Electric Compressor)

In the inverter-integrated electric compressor, as described above, it is necessary to enhance the cooling effect of the cooling structure for the inverter device portion and, also, it is necessary to take a countermeasure against vibrations, since the inverter device portion is continuously subjected to vibrations from the compressor mechanism portion and the electric motor portion. Accordingly, the inverter device portion is structured to be efficiently cooled by the sucked refrigerant as described in the aforementioned first to third embodiments and, also, the inverter device is more preferably structured in such a way as to take a countermeasure against vibrations.

The inverter circuit in the inverter device portion employs a current smoothing capacitor, which is an electric component with a relatively-larger size, and this current smoothing capacitor generally has a cylindrical shape. In cases where the current smoothing capacitor having such a shape is mounted on the circuit board, there is a need for a specific member for supporting the current smoothing capacitor as a countermeasure against vibrations, since it is impossible to cause the current smoothing capacitor to resist vibrations, by only mounting the current smoothing capacitor on the circuit board through securing of two lead terminals in the current smoothing capacitor thereto. However, even by taking such a countermeasure against vibrations, when the current smoothing capacitor is mounted on the circuit board, they are subjected to vibrations from the compressor mechanism portion and the electric motor portion, thereby causing failures thereof.

Therefore, there has been contrived a method for mounting the current smoothing capacitor in the inverter case, rather than mounting it on the circuit board, for alleviating the influence of vibrations, as a countermeasure thereagainst. In cases of mounting the current smoothing capacitor in the inverter case as described above, there is a need for providing electric-connection wiring using lead wires between the current smoothing capacitor and the circuit board, which necessitates securing a space for providing the electric-connection wiring inside the inverter device portion.

Further, the circuit board in the inverter device portion is mounted in the inverter case, by being secured, at its end portions, to the inverter case, through screws. In the circuit board secured as described above, vibrations occur at a resonance frequency, at portions of the circuit board inside the end portions secured through the screws (at portions closer to the center), due to vibrations over a wide frequency range from the compressor mechanism portion and the electric motor portion. This may result in the occurrence of accidents, such as fractures and disengagement of components mounted on the circuit board.

In fourth to seventh embodiments which will be described later, there will be described inverter-integrated electric compressors capable of further enhancing the vibration resistance of an inverter device, with a simple structure.

Further, while, in the fourth to seventh embodiments, there will be described the inverter-integrated electric compressors having enhanced vibration resistance, it is also possible to structure them to have the excellent cooling structures described in the aforementioned first to third embodiments, which can provide inverter-integrated electric compressors having more excellent properties. As a matter of course, the inverter-integrated electric compressors which will be described in the fourth to seventh embodiments are capable of effecting enhanced vibration resistance, even by themselves.

### Fourth Embodiment

Hereinafter, an inverter-integrated electric compressor according to a fourth embodiment of the present invention will be described, with reference to the accompanying drawings.

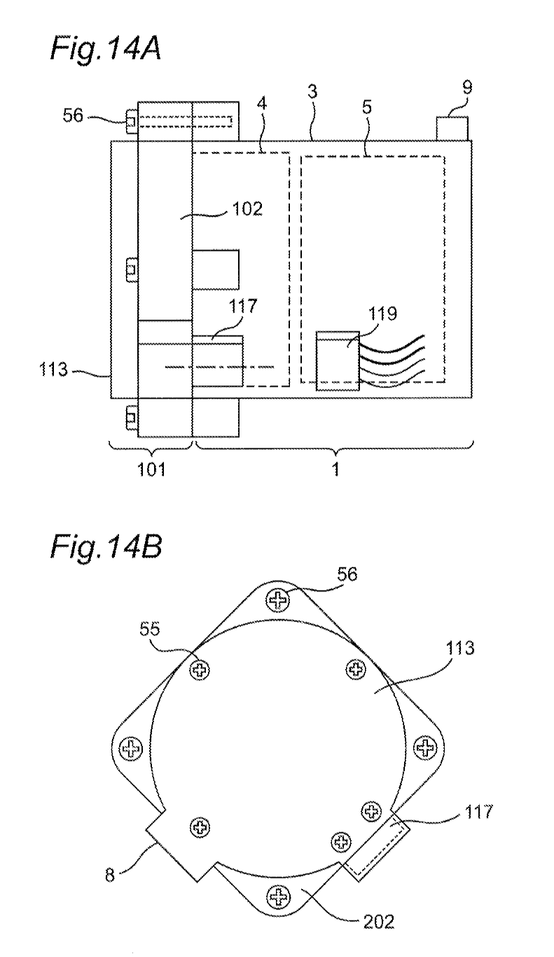

FIG. 14A and FIG. 14B are views illustrating the external structure of the inverter-integrated electric compressor according to the fourth embodiment of the present invention. FIG. 14A is a front view of the inverter-integrated electric compressor according to the fourth embodiment, and FIG. 14B is a left side view of the inverter-integrated electric compressor according to the fourth embodiment.

As illustrated in FIG. 14A, the inverter-integrated electric compressor according to the fourth embodiment is structured such that it is laterally installed through mounting legs (not illustrated) provided on the periphery of the body portion of an electric compressor portion 1.

The electric compressor portion 1 includes an electric motor portion 5 and a compressor mechanism portion 4, such that the electric motor portion 5 and the compressor mechanism portion 4 are housed within a main-body casing 3 in the electric-compressor portion 1. The electric motor portion 5 is driven and controlled by an inverter device portion 101. The compressor mechanism portion 4 being driven by the electric motor portion 5 is caused to suck a low-pressure refrigerant from a refrigeration cycle through a suction port 8 provided in an inverter case 102 and, further, is caused to compress and eject it. The refrigerant ejected from the compressor mechanism portion 4 enters the electric motor portion 5 and, then, is ejected, therefrom, through an ejection port 9 in the main-body casing 3 to the refrigeration cycle as a mechanism outside the inverter-integrated electric compressor, while cooling the electric motor portion 5.

The inverter case 102 is fastened to the main-body casing 3 through bolts 56. An inverter cover 113 is secured to the inverter case 102 through screws 55. The inverter device portion 101 is provided with a direct-mounted connector 117 for electrically connecting the inverter device portion 101 to an external connector 119.

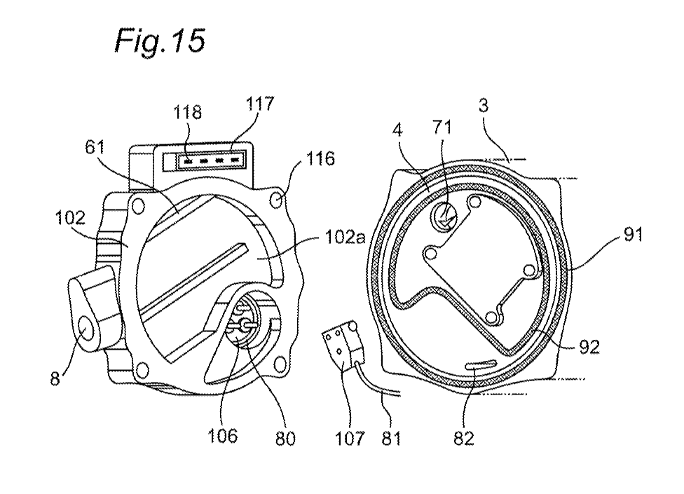

FIG. 15 is an exploded view of the structure of a suction refrigerant path 61 formed by the inverter case 102 and the compressor mechanism portion 4. The inverter case 102 and the compressor mechanism portion 4 are hermetically combined with each other using an O ring 92 to form the suction refrigerant path 61, which forms a suction path communicated with the suction port 8. The refrigerant sucked through the suction port 8 provided in the inverter case 102 is diffused within the suction refrigerant path 61, thereby cooling an end portion wall 102a in the inverter case 102. As a result thereof, a heat generating component such as a switching device module (for example, an IPM 105), which is mounted on the back surface of the end portion wall 102a, is cooled. The sucked refrigerant having cooled the switching device module and the like is flowed into the compressor space through a pass hole 71 in the compressor mechanism portion 4.

A compressor terminal 106 is secured to the inverter case 102 through a snap ring 80 as a fixing means. Further, the direct-mounted connector 117 is mounted, in a direct-mounted manner, in an end portion of the inverter case 102. In the fourth embodiment, there is illustrated an example where the direct-mounted connector 117 includes two terminals 118 for power supply and two terminals 118 for communication.

A lead wire 81 extended from the electric motor portion 5 is connected to a harness connector 107 through a communication path 82 provided near the outer periphery of the compressor mechanism portion 4 and, further, is electrically connected to the compressor terminal 106. The inverter case 102 is mechanically and hermetically coupled to the main-body casing 3 through the bolts 56 (see FIG. 14A) inserted through bolt passage holes 116, with an O ring 91 interposed therebetween. There is a lower pressure inside the aforementioned O ring 92, while there is a higher pressure in the area which is outside the O ring 92 but inside the O ring 91. This area communicates via the communication path 82 with an area around the electric motor portion 5 in which the high-pressure refrigerant 30 flows and, therefore, there is a higher pressure therein.

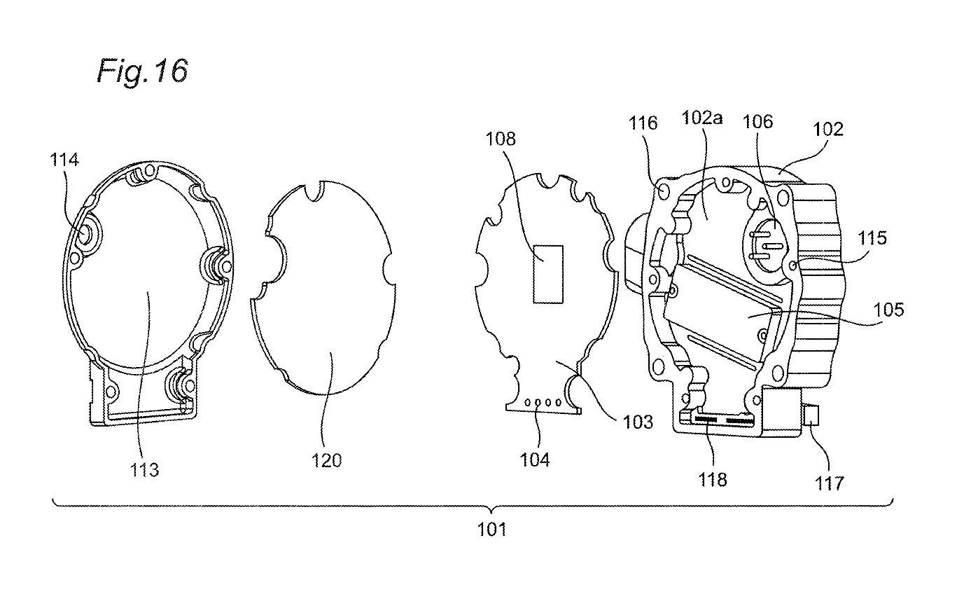

FIG. 16 is an exploded view illustrating the structure of the inverter-circuit side of the inverter device portion 101 which is provided with the IMP 105 as a switching device module, and the like. The IMP 105 having a flat-plate shape is secured through bolts to the end portion wall 102a in the inverter case 102, and the compressor terminal 106 is secured thereto through the snap ring 80 and the like. A circuit board 103 is placed such that it is overlaid on these inverter-circuit components, such as the IMP 105 and the compressor terminal 106, to form the inverter device portion 101. The IMP 105 includes plural switching devices which constitute an inverter circuit, which will be described later. The IMP 105 is provided, at its opposite sides, with connection terminal pins which are connected to the circuit board 103 through soldering. The circuit board 103 is secured at its peripheral end portion to the inverter case 102 through screws.

In the inverter-integrated electric compressor according to the fourth embodiment, a current smoothing capacitor 108, which is of a surface-mounting type and has a flat-plate shape, is mounted on the circuit board 103 through soldering, such that a flat surface of the current smoothing capacitor 108 is faced to the circuit board 103. The terminals 118 in the direct-mounted connector 117 are directly connected, through soldering, to terminal mounting holes 104 in the circuit board 103, which is placed orthogonally to the rotational center axis of the electric compressor portion 1.

The inverter cover 113 is secured to the inverter case 102, by inserting screws 55 through screw passage holes 114 therein and fastening them to screw holes 115 in the inverter case 102. The inverter circuit and the like inside the inverter case 102 are protected by the inverter cover 113. Further, a sheet member 120 is attached to the inner surface of the inverter cover 11, which provides a sound insulating and vibration damping structure. As a result thereof, the inverter-integrated electric compressor according to the fourth embodiment is adapted to prevent noise generated from the electric motor portion 5 and the compressor mechanism portion 4 from leaking to the outside.

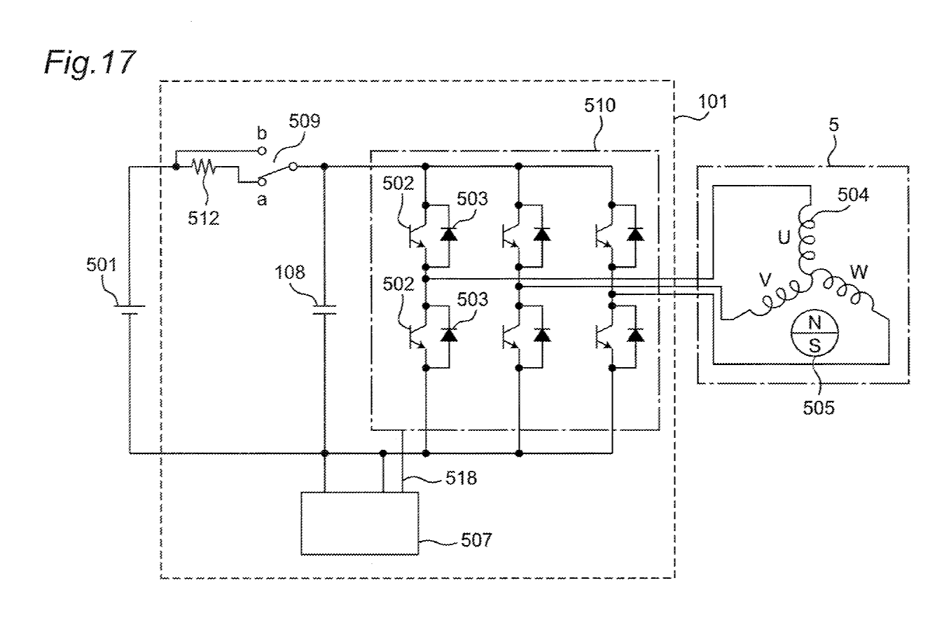

FIG. 17 illustrates an electric circuit diagram of the inverter device portion 101 and peripheries thereof, in the inverter-integrated electric compressor according to the fourth embodiment.

Hereinafter, there will be described the general outline of actions in the inverter-integrated electric compressor according to the fourth embodiment. Before operations, the current smoothing capacitor 108 is charged by a battery 501 which is constituted by a DC power supply, through a resistor 512, and a contact point a in a relay 509, in the inverter device portion 101. After the current smoothing capacitor 108 has been charged, the relay 509 is changed over to a contact point b, thereby enabling supply of electric power to the inverter circuit 510.

In operation, a control circuit 507 controls the plural switching devices 502 forming the inverter circuit 510 through a connection line 518, for performing switching, therewith, on the DC voltage from the battery 501, through PWM modulation, to create an AC electric current, and this AC electric current is outputted to the stator winding 504 constituting the electric motor portion 5. As a result thereof, the rotator 505 in the electric motor portion 5 is driven thereby. Further, in the fourth embodiment, there will be described an example where the plural switching devices 502 are constituted by the IPM 105, but the respective switching devices can be also constituted by IGBTs, FETs, and transistors.

The inverter circuit 510 includes diodes 503 which form circulation routes for the electric current flowing through the stator winding 504. The control circuit 507 also performs estimation of the position of the magnet rotator 505, protection of the switching devices 502, calculations of electric power consumption, communications with a controller which generates commands for control of the operating rotation speed, and the like.

The current smoothing capacitor 108 smoothens the switching electric current resulted from the DC/AC conversion by the inverter circuit 510. Further, the current smoothing capacitor 108 meets specifications which provide excellent voltage resistance, since it is connected to the battery 501. Therefore, the current smoothing capacitor 108 is a component having a shape with a relatively-larger size.

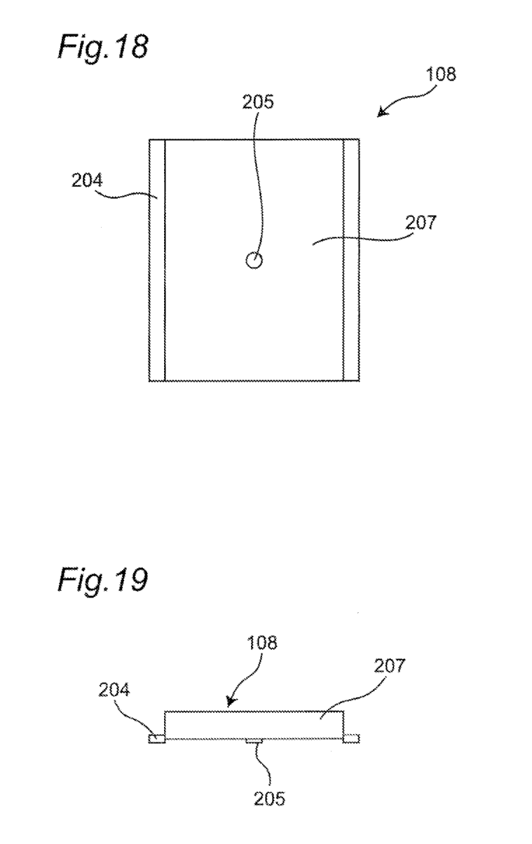

FIG. 18 is a rear view of the current smoothing capacitor 108, and FIG. 19 is a side view of the current smoothing capacitor 108. The current smoothing capacitor 108 having a flat-plate shape includes a main body 207 which is provided with electrode terminals 204, at its opposite sides. Before soldering connecting processing such as solder dipping or reflowing, an adhesive agent 205 has been deposited on the current smoothing capacitor 108 at a center portion thereof, in order to secure the surface-mounting type current smoothing capacitor 108 to the circuit board 103.

The current smoothing capacitor 108 secured to the circuit board 103 through the adhesive agent 205 is connected and secured, at the electrode terminals 204 therein, to the circuit board 103 through soldering. The current smoothing capacitor 108 is a hard component which has a flat-plate shape and a relatively-larger size and is covered with a resin. The current smoothing capacitor 108 mounted on the circuit board 103 is placed, such that its larger flat surface faces the circuit board 103, and the larger flat surface is secured to the circuit board 103 at its center portion and its opposite side portions. Since the current smoothing capacitor 108 is surface-mounted on the circuit board 103 as described above, the circuit board 103 is strengthened around its position at which the current smoothing capacitor 108 is surface-mounted thereon against vibrations, which improves the vibration resistance performance of the circuit board 103 itself.

With the inverter device portion 101 having the aforementioned structure, it is possible to eliminate the necessity of taking a countermeasure against vibrations, such as provision of an additional fixing means such as screws in the circuit board 103.

Further, since the current smoothing capacitor 108 has a flat-plate shape and is placed to have a smaller height such that its flat surface faces the circuit board 103, there is no need for providing a specific member for supporting the current smoothing capacitor 108 as a countermeasure against vibrations. Further, since the current smoothing capacitor 108 is mounted on the circuit board 103, there is no need for electric-connection wiring using lead wires between the current smoothing capacitor 108 and the circuit board 103.

In the inverter device portion 101 according to the fourth embodiment, the current smoothing capacitor 108 is constituted by a ceramic capacitor, which can further strengthen the circuit board 103 itself against vibrations, around its portion on which the current smoothing capacitor is surface-mounted, since the ceramic capacitor has higher hardness and strength.

As described above, with the inverter-integrated electric compressor according to the fourth embodiment, it is possible to enhance the vibration resistance of the inverter device portion with a simple structure, without using an additional member.

Further, while, in the fourth embodiment, there has been described an example of a lateral-type inverter-integrated electric compressor which is mounted in a lateral direction, the present invention is not limited to such a lateral type and can be also applied to a longitudinal-type inverter-integrated electric compressor.

Further, the present invention is not limited to the structures according to the fourth embodiment, regarding the aspect of the electric compressor portion 1 and the aspect of the cooling structure for the inverter device portion 101. While, in the fourth embodiment, the resistor 512 and the relay 509 are included in the inverter device portion 101, the resistor 512 and the relay 509 can be also provided outside the inverter device portion 101.

While, in the fourth embodiment, there has been described a case where each electrode terminal 204 in the current smoothing capacitor 108 is constituted by a single metal plate, they can be also constituted by plural pin terminals which are connected to the circuit board similarly, which can also offer the same effects.

### Fifth Embodiment

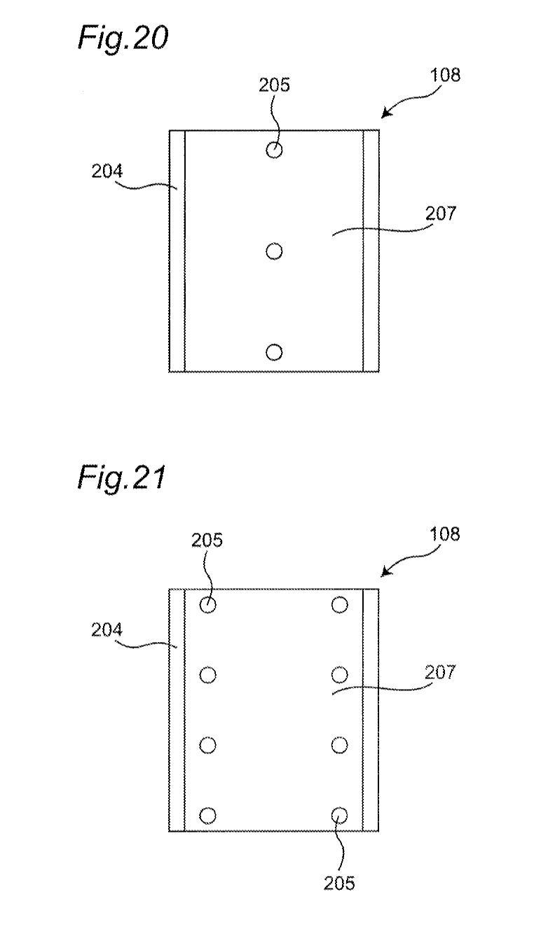

Hereinafter, an inverter-integrated electric compressor according to a fifth embodiment of the present invention will be described, with reference to the accompanying FIG. 20. FIG. 20 is a rear view of a current smoothing capacitor in the inverter-integrated electric compressor according to the fifth embodiment. The inverter-integrated electric compressor according to the fifth embodiment is different from the inverter-integrated electric compressor according to the aforementioned fourth embodiment, in terms of the structure for mounting the current smoothing capacitor 108 on a circuit board 103, but the other portions are the same thereas. Accordingly, in the following description about the fifth embodiment, differences thereof from the fourth embodiment will be described.

In the current smoothing capacitor 108 according to the fifth embodiment, as illustrated in FIG. 20, in comparison with the current smoothing capacitor 108 according to the fourth embodiment illustrated in FIG. 18, an adhesive agent 205 has been deposited thereon at three positions thereon, in order to secure the surface-mounting type current smoothing capacitor 108 to the circuit board 103, before soldering connecting processing such as solder dipping, reflowing. The three positions at which the adhesive agent 205 is deposited thereon are positions near the opposite end portions of the current smoothing capacitor 108 which are provided with no electrode terminal 204, in addition to a center position on the back surface of the current smoothing capacitor 108. In the fifth embodiment, the three positions at which the adhesive agent 205 is deposited thereon are aligned, in parallel, longitudinally at the middle, along the electrode terminals 204 at the opposite sides of the current smoothing capacitor 108.

In the fifth embodiment having the aforementioned structure, the surface-mounting type current smoothing capacitor 108 is secured to the circuit board 103, by securing them with the adhesive agent 205 at the three positions in the single row, in addition to securing through soldering in the two rows at the electrodes 204, and, therefore, by securing in three rows in total. Therefore, in the inverter-integrated electric compressor according to the fifth embodiment, the inverter device portion is structured in such a way as to strengthen the securing of the surface-mounting-type current smoothing capacitor 108 to the circuit board 103.

In the inverter-integrated electric compressor according to the fifth embodiment, the circuit board 103 itself has an increased strength, around its portion on which the current smoothing capacitor 108 is surface-mounted, against vibrations.

### Sixth Embodiment

Hereinafter, an inverter-integrated electric compressor according to a sixth embodiment of the present invention will be described, with reference to the accompanying FIG. 21. FIG. 21 is a rear view of a current smoothing capacitor in the inverter-integrated electric compressor according to the sixth embodiment. The inverter-integrated electric compressor according to the sixth embodiment is different from the inverter-integrated electric compressor according to the aforementioned fourth embodiment, in terms of the structure for mounting the current smoothing capacitor 108 on a circuit board 103, but the other portions are the same thereas. Accordingly, in the following description about the sixth embodiment, differences thereof from the fourth embodiment will be described.

In the current smoothing capacitor 108 according to the sixth embodiment, as illustrated in FIG. 21, in comparison with the current smoothing capacitor 108 according to the fourth embodiment illustrated in FIG. 18, an adhesive agent 205 has been deposited thereon at plural portions which are parallel with each other, along electrode terminals 204 at the opposite sides of the current smoothing capacitor 108, in order to secure the surface-mounting type current smoothing capacitor 108 to the circuit board 103, before soldering connecting processing such as solder dipping, reflowing. Further, the positions at which the adhesive agent 205 is deposited thereon are positions (four positions) near the opposite end portions of the current smoothing capacitor 108 which are provided with the electrode terminals 204, wherein these positions are provided at even intervals along the respective electrode terminals 204. Accordingly, in the sixth embodiment, the positions at which the adhesive agent 205 is deposited thereon are eight positions in two rows and, further, are arranged in parallel along the electrode terminals 204 at the opposite sides of the current smoothing capacitor 108.

In the sixth embodiment having the aforementioned structure, the surface-mounting type current smoothing capacitor 108 is secured to the circuit board 103, by securing them with the adhesive agent at the eight positions in the two rows, in addition to securing through soldering in the two rows at the electrodes 204, and, therefore, by securing in four rows in total. Therefore, in the inverter-integrated electric compressor according to the sixth embodiment, the inverter device portion is structured in such a way as to strengthen the securing of the surface-mounting-type current smoothing capacitor 108 to the circuit board 103.

### Seventh Embodiment

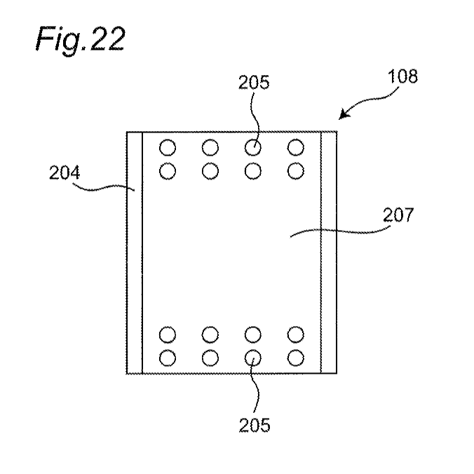

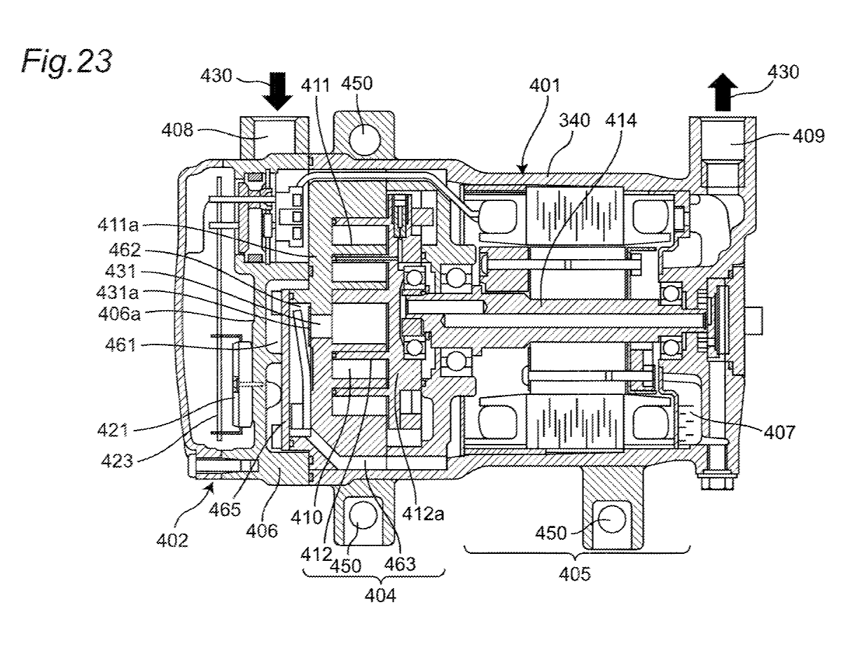

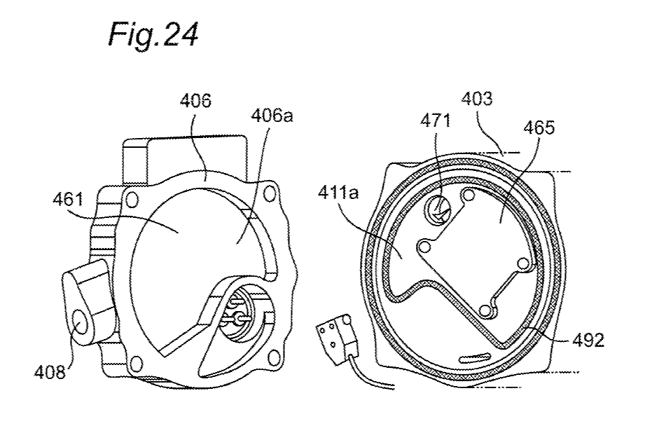

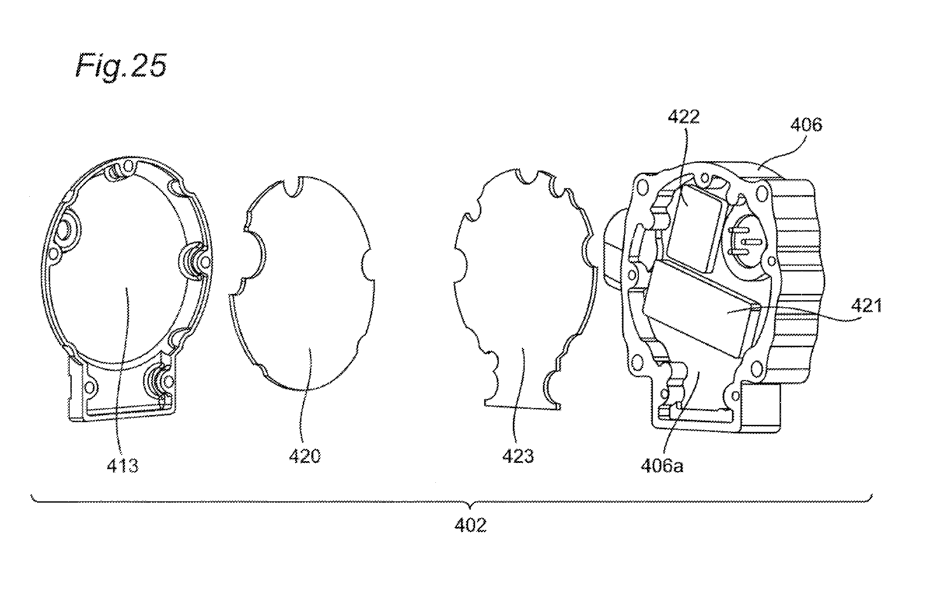

Hereinafter, an inverter-integrated electric compressor according to a seventh embodiment of the present invention will be described, with reference to the accompanying FIG. 22. FIG. 22 is a rear view of a current smoothing capacitor in the inverter-integrated electric compressor according to the seventh embodiment. The inverter-integrated electric compressor according to the seventh embodiment is different from the inverter-integrated electric compressor according to the aforementioned fourth embodiment, in terms of the structure for mounting the current smoothing capacitor 108 on a circuit board 103, but the other portions are the same thereas. Accordingly, in the following description about the seventh embodiment, differences thereof from the fourth embodiment will be described.

In the current smoothing capacitor 108 according to the seventh embodiment, as illustrated in FIG. 22, in comparison with the current smoothing capacitor 108 according to the fourth embodiment illustrated in FIG. 18, an adhesive agent 205 has been deposited on the rear surface of the current smoothing capacitor 108 at plural positions thereon, in order to secure the surface-mounting type current smoothing capacitor 108 to the circuit board 103, before soldering connecting processing such as solder dipping, reflowing. The plural positions at which the adhesive agent 205 is deposited thereon are plural positions provided along the opposite sides of the current smoothing capacitor 108 which are provided with no electrode terminal 204 (the upper end portion and the lower end portion in FIG. 22). In the seventh embodiment, they are provided in two rows (eight positions) along the opposite sides which are not provided with the electrode terminals 204.

In the seventh embodiment having the aforementioned structure, the surface-mounting type current smoothing capacitor 108 is secured to the circuit board 103, by securing them with the adhesive agent at the opposite sides which are not provided with the electrode terminals 204, in addition to securing through soldering in the two rows at the electrodes 204. Accordingly, with the structure according to the seventh embodiment, the plate-shaped and surface-mounting type current smoothing capacitor 108 is certainly secured at all of its four sides to the circuit board 103. Accordingly, in the inverter-integrated electric compressor according to the seventh embodiment, the inverter device portion is structured in such a way as to strengthen the securing of the surface-mounting-type current smoothing capacitor 108 to the circuit board 103, thereby further strengthening the circuit board 103 around its portion on which it is surface-mounted, against vibrations. Further, in cases of visually checking the presence or absence of missing of deposition of the adhesive agent 205 thereon, in a lateral direction, after the surface mounting, it is possible to certainly and easily check whether the adhesive agent has been deposited thereon, since the adhesive agent 205 is at positions which are not hidden by the electrode terminals 204 (at visually-recognizable positions).

Further, the inverter-integrated electric compressor according to the present invention is made to have a smaller size. Therefore, by mounting it in a vehicle such as an automobile, it is possible to cause it to effect its excellent vibration resistance performance, thereby improving the reliability of the vehicle.

In the inverter-integrated electric compressor according to the present invention, in the inverter device portion, the inverter-circuit current smoothing capacitor is made to have a flat-plate shape and to be of a surface-mounting type and, further, is mounted on the circuit board in the inverter device portion. This eliminates the necessity of providing a member for supporting the capacitor as a countermeasure against vibrations, since the current smoothing capacitor has the flat-plate shape. Further, since the current smoothing capacitor is mounted on the circuit board, there is no need for electric-connection wiring using lead wires between the current smoothing capacitor and the circuit board.

According to the present invention, the current smoothing capacitor, which is formed from a capacitor with a relatively-larger size, has a fiat-plate shape and is surface-mounted on the circuit board, which causes the circuit board to have an increased strength against vibrations, around its portion on which the current smoothing capacitor is surface-mounted. This eliminates the necessity of taking a countermeasure, such as provision of an additional fixing means such as screws at the center portion of the circuit board. Accordingly, with the present invention, it is possible to enhance the vibration resistance of the inverter device portion, in the inverter-integrated electric compressor, without using an additional member.

### INDUSTRIAL APPLICABILITY

The inverter-integrated electric compressor according to the present invention is capable to cooling the inverter device with the sucked refrigerant, without involving adjustments of operating conditions for the refrigeration cycle. Accordingly, the inverter-integrated electric compressor can be applied to various types of consumer-intended and industrial-intended inverter-integrated electric compressors, thereby forming compressors with excellent general versatility.

### REFERENCE SIGNS LIST

1 Electric compressor portion
3 Main-body casing
4 Compressor mechanism portion
5 Electric motor portion
8 Suction port
9 Ejection port
11 Fixed spiral portion
11a Fixed end plate
12 Circling spiral portion
12a Circling end plate
30 Refrigerant
61 Suction refrigeration path
65 Lid member
101, 121, 141 Inverter device portion
102, 122, 142 Inverter case
102a, 122a End portion wall
103 Circuit board
105 IPM
108 Current smoothing capacitor
113 Inverter cover
211 First path restriction portion
212 Second path restriction portion
213 First path guide portion
214 Second path guide portion

1. An inverter-integrated electric compressor incorporating an inverter device portion adapted to be cooled by a sucked refrigerant,
wherein there is formed a suction refrigerant path for intensively flowing the sucked refrigerant therethrough, in a surface which is opposite from a wall surface being in contact with a main heat source in the inverter device portion, at a position coincident with the position at which the main heat source is installed.

2. The inverter-integrated electric compressor according to claim 1,
wherein the inverter device portion is placed adjacent to a compressor mechanism portion, and the suction refrigerant path for intensively flowing the sucked refrigerant therethrough is formed between the inverter device portion and the compressor mechanism portion.

3. The inverter-integrated electric compressor according to claim 1,
wherein the main heat source in the inverter device portion comprises a module including integrated semiconductor chips forming plural switching devices in an inverter circuit.

4. The inverter-integrated electric compressor according to claim 1,
wherein, in the surface which is opposite from the wall surface being in contact with the main heat source in the inverter device, at positions coincident with the position at which the main heat source is installed,
a first path restriction portion and a second path restriction portion are formed oppositely to each other, and the first path restriction portion and the second path restriction portion form opposite side wall surfaces of the suction refrigerant path along a flow of the sucked refrigerant, whereby the sucked refrigerant intensively flows through the suction refrigerant path.

5. The inverter-integrated electric compressor according to claim 1,
wherein, in the wall surface being in contact with the main heat source in the inverter device portion,
a first path guide portion having a concave shape and a second path guide portion having a concave shape are formed oppositely to each other, such that the heat source is inside them, and
the first path guide portion and the second path guide portion form opposite side wall surfaces of the suction refrigerant path along a flow of the sucked refrigerant, whereby the sucked refrigerant intensively flows through the suction refrigerant path.

6. The inverter-integrated electric compressor according to claim 1,
wherein the compressor mechanism portion includes a portion which forms an ejection room adapted such that a high-pressure refrigerant is ejected thereinto, and this portion is structured to be spaced apart from the surface opposite from the wall surface being in contact with the heat source, by a substantially constant interval, over the area other than the area provided with the suction refrigerant path.

7. The inverter-integrated electric compressor according to claim 1,
wherein the inverter device portion includes an inverter circuit including a surface-mounting type current smoothing capacitor having a flat-plate surface, and the current smoothing capacitor is mounted on a circuit board in the inverter device portion.

8. The inverter-integrated electric compressor according to claim 7,
wherein the current smoothing capacitor comprises a ceramic capacitor.

9. The inverter-integrated electric compressor according to claim 7,
wherein the current smoothing capacitor is secured to the circuit board, through an adhesive agent, in addition to soldering.

10. The inverter-integrated electric compressor according to claim 9,
wherein the current smoothing capacitor is secured to the circuit board through the adhesive agent, at an end portion of the current smoothing capacitor which is provided with no electrode terminal.

11. The inverter-integrated electric compressor according to claim 1,
wherein the inverter-integrated electric compressor is mounted in a vehicle.
